(19) United States
(12) Patent Application Publication
(10) Pub. No.: US 2026/0110047 A1
(43) Pub. Date: Apr. 23, 2026

(54) NON-ORIENTED ELECTRICAL STEEL SHEET AND METHOD FOR PRODUCING SAME

(71) Applicant: NIPPON STEEL CORPORATION, Tokyo (JP)

(72) Inventors: Yoshiaki NATORI, Chiyoda-ku, Tokyo (JP); Hiroyoshi YASHIKI, Chiyoda-ku, Tokyo (JP); Tesshu MURAKAWA, Chiyoda-ku, Tokyo (JP); Minako FUKUCHI, Chiyoda-ku, Tokyo (JP)

(73) Assignee: NIPPON STEEL CORPORATION, Tokyo (JP)

(21) Appl. No.: 19/155,889

(22) PCT Filed: Feb. 14, 2024
(86) PCT No.: PCT/JP2024/005121

§ 371 Date: Aug. 12, 2025

(30) Foreign Application Priority Data
Feb. 15, 2023 (JP) 2023-022042

(51) Int. Cl. C21D 9/46; C21D 6/00; C21D 8/1216; C21D 8/1244; C22C 38/00; C22C 38/04; C22C 38/06; C22C 38/20; C22C 38/22; C22C 38/28; C22C 38/34; C22C 38/60; H01F 1/147

(52) U.S. Cl. CPC C21D 9/46; C21D 6/008; C21D 8/1222; C21D 8/1233; C21D 8/125; C21D 8/1272; C22C 38/001; C22C 38/002; C22C 38/005; C22C 38/008; C22C 38/04; C22C 38/06; C22C 38/20; C22C 38/22; C22C 38/28; C22C 38/34; C22C 38/60; H01F 1/14783; C22C 2202/02

(57) ABSTRACT

In a non-oriented electrical steel sheet according to the present disclosure, TS is higher than 580 MPa, and when P₁₂₀/Fe₇₀₀ that is a ratio of a peak-to-peak value P₁₂₀ of P around an electron energy of 120 eV to a peak-to-peak value Fe₇₀₀ of Fe around an electron energy of 700 eV in Auger differential spectra obtained in a grain boundary region of a fracture surface is defined as [P]_{GB}, and P₁₂₀/Fe₇₀₀ that is a ratio of a P₁₂₀ to Fe₇₀₀ in Auger differential spectra obtained in an intragranular region of a fracture surface is defined as [P]_{IG}, the [P]_{GB} and the [P]_{IG} satisfy Formula (1). A difference ΔS between TS and YP is 110 MPa or less, and an average grain size D (μm) satisfies Formula (2).

$${[ P ]}_{G B} {/ [ P ]}_{IG} > 2. \qquad ( 1 )$$

$$D \leq 100 - 15 \times {[ P ]}_{G B} {/ [ P ]}_{I G} + 1 \; 500 / TS \qquad ( 2 )$$

### TECHNICAL FIELD

The present disclosure relates to a non-oriented electrical steel sheet and a method for producing the non-oriented electrical steel sheet.

### BACKGROUND ART

Non-oriented electrical steel sheets are widely utilized as motor cores (iron cores). Motor cores include stators that are stationary parts, or rotors that are rotating parts or the like. The characteristics required for stators and rotors are different. A stator is required to have excellent magnetic properties (low iron loss and high magnetic flux density). On the other hand, although a rotor is required to have magnetic properties, a rotor is, in particular, required to have high strength for the following reasons. In recent years, motors for use in electric vehicles and hybrid vehicles are being designed to increase motor output by increasing the motor rotation speed. Therefore, the loads applied to the rotors, which are rotating parts, during operation of the motors are increasing. Therefore, the rotors are required to have high strength. As a result, a non-oriented electrical steel sheet that will serve as a starting material for a motor core such as a stator or a rotor is required to have high strength and excellent magnetic properties.

A non-oriented electrical steel sheet that has high strength and excellent magnetic properties is proposed in Japanese Patent Application Publication No. 2008-050686 (Patent Literature 1). According to Patent Literature 1, high strength and excellent magnetic properties are realized by appropriately adjusting the chemical composition.

### CITATION LIST

### Patent Literature

Patent Literature 1: Japanese Patent Application Publication No. 2008-050686

### SUMMARY OF INVENTION

### Technical Problem

In this connection, when producing a motor core from a non-oriented electrical steel sheet, the non-oriented electrical steel sheet is subjected to blanking. If the strength of the non-oriented electrical steel sheet is high, it will be difficult to cut out the steel sheet into a desired shape during blanking, and in some cases the dimensional accuracy of the cut starting material may decrease. In addition, when a non-oriented electrical steel sheet is pushed into a die by a blanking punch, a shear droop occurs at an edge of the processed starting material. A motor core is produced by laminating a plurality of sheet-shaped motor core starting materials cut out from non-oriented electrical steel sheets. If a shear droop has occurred in the motor core starting materials after processing, it may be difficult to laminate the motor core starting materials together with high accuracy. Therefore, even if a non-oriented electrical steel sheet has high strength, there is a need for the non-oriented electrical steel sheet to also have excellent blanking workability that can improve the dimensional accuracy of the shape of the starting material after blanking and can suppress the occurrence of a shear droop.

An objective of the present disclosure is to provide a non-oriented electrical steel sheet in which, despite having high strength, excellent magnetic properties are obtained and excellent blanking workability is obtained, and a method for producing the non-oriented electrical steel sheet.

### Solution to Problem

A non-oriented electrical steel sheet of the present disclosure consists of, in mass %, Si: 3.2 to 4.5%, Mn: 0.3 to 3.5%, sol. Al: 0.2 to 2.0%, C: 0.0010 to 0.0030%, N: more than 0% to 0.0050% or less, O: more than 0% to 0.0200% or less, P: more than 0% to 0.100% or less, S: more than 0% to 0.0030% or less, Ti: more than 0% to 0.0030% or less, Mo: 0 to 0.100%, Cr: 0 to 1.000%, Ni: 0 to 0.50%, Cu: 0 to 0.50%, B: 0 to 0.0010%, Zn: 0 to 0.0050%, Ga: 0 to 0.0050%, Ge: 0 to 0.0050%, As: 0 to 0.0100%, Sn: 0 to 0.20%, Sb: 0 to 0.10%, Ca: 0 to 0.0050%, La: 0 to 0.0050%, Ce: 0 to 0.0050%, Nd: 0 to 0.0010%, and Mg: 0 to 0.0030%, with the balance being Fe and impurities, and has a tensile strength TS that is higher than 580 MPa. Elemental analysis is performed by Auger electron spectroscopy in a grain boundary region of a fracture surface of the non-oriented electrical steel sheet to obtain Auger differential spectrum of Fe and P, and P₁₂₀/Fe₇₀₀ that is a ratio of a peak-to-peak value P₁₂₀ of P around an electron energy of 120 eV to a peak-to-peak value Fe₇₀₀ of Fe around an electron energy of 700 eV in the Auger differential spectrum obtained is defined as [P]_{GB}. Elemental analysis is performed by Auger electron spectroscopy in an intragranular region of a fracture surface of the non-oriented electrical steel sheet to obtain Auger differential spectrum of Fe and P, and P₁₂₀/Fe₇₀₀ that is a ratio of a peak-to-peak value P₁₂₀ of P around an electron energy of 120 eV to a peak-to-peak value Fe₇₀₀ of Fe around an electron energy of 700 eV in the Auger differential spectrum obtained is defined as [P]_{IG}. At this time, in the non-oriented electrical steel sheet, Formula (1) is satisfied. In the non-oriented electrical steel sheet, in addition, a difference ΔS between the tensile strength TS and a yield strength YP is 110 MPa or less, and an average grain size D (μm) satisfies Formula (2):

$${[ P ]}_{G B} {/ [ P ]}_{IG} > 2. \qquad ( 1 )$$

$$D \leq 100 - 15 \times {[ P ]}_{G B} {/ [ P ]}_{I G} + 1 \; 500 / TS \qquad ( 2 )$$

where, a numerical value of the tensile strength TS (MPa) is substituted for TS in Formula (2).

A method for producing a non-oriented electrical steel sheet of the present disclosure includes a hot rolling process, a cold rolling process, and a final annealing process. In the hot rolling process, a slab having the chemical composition described above is subjected to hot rolling to produce a hot-rolled steel sheet. In the cold rolling process, the hot-rolled steel sheet is subjected to cold rolling to produce a cold-rolled steel sheet. In the final annealing process, the cold-rolled steel sheet is subjected to final annealing. In the final annealing process, the cold-rolled steel sheet is annealed at a highest temperature reached T1 of 950° C. or less, a tension TE1 applied to the cold-rolled steel sheet during annealing is set to 0.15 to 0.80 kgf/mm², an average cooling rate CR1 in a temperature range of 700 to 500° C. during cooling of the cold-rolled steel sheet after annealing is set to 20° C./sec or less, and a maximum tension TE2 applied to the cold-rolled steel sheet in a temperature range of 200° C. or less during cooling of the cold-rolled steel sheet after annealing is set to TE1+0.15 kgf/mm² or more and 0.40 kgf/mm² or more.

### Advantageous Effects of Invention

In the non-oriented electrical steel sheet of the present disclosure, despite having high strength, excellent magnetic properties are obtained and excellent blanking workability is obtained. The method for producing a non-oriented electrical steel sheet according to the present invention can produce the non-oriented electrical steel sheet described above.

### BRIEF DESCRIPTION OF DRAWINGS

FIG. 1 is an SEM image of a fracture surface of a non-oriented electrical steel sheet of the present embodiment.

FIG. 2 is an enlarged view of a grain boundary region in FIG. 1.

FIG. 3 is a diagram showing an example of Auger differential spectrum of Fe and P obtained by performing elemental analysis by Auger electron spectroscopy in the grain boundary region shown in FIG. 2.

FIG. 4 is an enlarged view of a portion including a cut end surface in an L-direction cross section of a ring-shaped sample in a blanking workability evaluation test in an example.

### DESCRIPTION OF EMBODIMENTS

In order to obtain both excellent strength required for a rotor and excellent magnetic properties required for a stator from a single non-oriented electrical steel sheet, the present inventors conducted studies from the viewpoint of the chemical composition with respect to a non-oriented electrical steel sheet which has high strength and which is also excellent in magnetic properties. As a result, the present inventors have considered that if a non-oriented electrical steel sheet has a chemical composition consisting of, in mass %, Si: 3.2 to 4.5%, Mn: 0.3 to 3.5%, sol. Al: 0.2 to 2.0%, C: 0.0010 to 0.0030%, N: more than 0% to 0.0050% or less, O: more than 0% to 0.0200% or less, P: more than 0% to 0.100% or less, S: more than 0% to 0.0030% or less, Ti: more than 0% to 0.0030% or less, Mo: 0 to 0.100%, Cr: 0 to 1.000%, Ni: 0 to 0.50%, Cu: 0 to 0.50%, B: 0 to 0.0010%, Zn: 0 to 0.0050%, Ga: 0 to 0.0050%, Ge: 0 to 0.0050%, As: 0 to 0.0100%, Sn: 0 to 0.20%, Sb: 0 to 0.10%, Ca: 0 to 0.0050%, La: 0 to 0.0050%, Ce: 0 to 0.0050%, Nd: 0 to 0.0010%, and Mg: 0 to 0.0030%, with the balance being Fe and impurities, excellent magnetic properties can be obtained while also having a tensile strength higher than 580 MPa.

Therefore, the present inventors also conducted studies regarding means for realizing excellent blanking workability in a non-oriented electrical steel sheet having the chemical composition described above. As a result, the present inventors obtained the following finding.

The present inventors subjected a non-oriented electrical steel sheet having a tensile strength higher than 580 MPa to blanking, and observed the shear surface thereof. In a non-oriented electrical steel sheet having a tensile strength of 580 MPa or less, a shear surface after blanking mainly consists of a ductile fracture surface. In contrast, in a shear surface obtained after blanking of a non-oriented electrical steel sheet having a tensile strength that is higher than 580 MPa, the proportion constituted by a brittle fracture surface increased in comparison to a shear surface after blanking of a non-oriented electrical steel sheet having a tensile strength of 580 MPa or less. Furthermore, in the brittle fracture surface, a proportion constituted by intragranular fracture surfaces (cleavage fracture surfaces) was higher than a proportion constituted by grain boundary fracture surfaces. The cleavage propagates along the cleavage plane ((100) plane). The cleavage plane does not necessarily exist along the cutting direction. Consequently, cracks propagate with unevenness, and the dimensional accuracy of the shape of the sheared surface decreases. On the other hand, in a case where a cleavage fracture and a grain boundary fracture are mixed, in comparison to the case of only a cleavage fracture, a fracture surface that is closer to the cutting target position is selected and cut. Therefore, a deviation in the cutting position is reduced and the dimensional accuracy of the shear surface increases.

Based on the above finding, the present inventors have considered that, during blanking of a non-oriented electrical steel sheet having a tensile strength higher than 580 MPa, by increasing the proportion of grain boundary fracture surfaces, the dimensional accuracy of the shear surface will increase and, as a result, the blanking workability will increase. Then, the present inventors have considered that if the amount of P segregation at grain boundaries is increased, the proportion of grain boundary fracture surfaces during blanking can be increased. Therefore, the present inventors investigated the relation between the amount of P segregation at grain boundaries and blanking workability. As a result, the present inventors have discovered that when [P]_{GB} that is an index of the P concentration in a grain boundary region and [P]_{IG} that is an index of the P concentration in an intragranular region, which are each determined by Auger electron spectroscopy that is described later, satisfy Formula (1), excellent blanking workability is obtained.

$${[ P ]}_{G B} {/ [ P ]}_{I G} > 2.0 \qquad ( 1 )$$

However, even when [P]_{GB}/[P]_{IG} satisfied Formula (1), a shear droop was still confirmed at the shear surface after blanking. Therefore, the present inventors conducted further studies regarding means for suppressing the occurrence of a shear droop occurring due to blanking. As a result, the present inventors obtained the following finding.

In the blanking process, fracturing occurs through elastic deformation and plastic deformation. Even if the amount of P segregation at the grain boundaries can be increased to increase the proportion of grain boundary fractures during blanking, the plastic deformation before fracturing cannot be eliminated. This plastic deformation remains as a shear droop. Therefore, the present inventors investigated means for suppressing plastic deformation in a case where an intragranular fracture occurs. Plastic deformation occurs during a period from after an external force equal to or greater than the yield strength YP is applied to the steel sheet until an external force equal to or greater than the tensile strength TS is applied to the steel sheet and the steel sheet fractures. Therefore, the present inventors have considered that in a non-oriented electrical steel sheet having the chemical composition described above, plastic deformation can be suppressed by reducing a difference ΔS between the tensile strength TS and the yield strength YP. As a result of further investigation, the present inventors have discovered that by making [P]_{GB}/[P]_{IG} higher than 2.0 and making the difference ΔS between the tensile strength TS and the yield strength YP 110 MPa or less, dimensional accuracy after blanking is excellent, the occurrence of a shear droop at the shear surface is sufficiently suppressed, and excellent blanking workability is obtained.

By adopting the chemical composition described above, making [P]_{GB}/[P]_{IG} higher than 2.0, and making the difference ΔS between the tensile strength TS and the yield strength YP 110 MPa or less, excellent blanking workability can be obtained even in high-strength non-oriented electrical steel sheets in which the tensile strength TS is more than 580 MPa. However, in such non-oriented electrical steel sheets, the toughness became lower in some cases. When using a non-oriented electrical steel sheet as a rotor, excellent toughness is also required, and not only high strength. Therefore, the present inventors also conducted studies regarding means for obtaining excellent toughness. As a result, the present inventors obtained the following finding.

In a non-oriented electrical steel sheet, the higher the value of [P]_{GB} that indicates the amount of P segregation at grain boundaries is, and the higher the tensile strength TS of the non-oriented electrical steel sheet is, the more likely that the toughness of the non-oriented electrical steel sheet will decrease. Therefore, the average grain size D (μm) of the non-oriented electrical steel sheet should be made a size that corresponds [P]_{GB} and the tensile strength TS. In such case, there is a possibility that appropriate toughness will be obtained.

Therefore, the present inventors investigated the relation between the average grain size D, [P]_{GB} and the tensile strength TS, and toughness. As a result, the present inventors have discovered that if the average grain size D satisfies Formula (2), excellent toughness is obtained even when the non-oriented electrical steel sheet has the chemical composition described above, the tensile strength TS is made higher than 580 MPa, [P]_{GB}/[P]_{IG} is made higher than 2.0, and the difference ΔS between the tensile strength TS and the yield strength YP is made 110 MPa or less:

$$D \leq 100 - 15 \times {[ P ]}_{G B} {/ [ P ]}_{I G} + 1 \; 500 / TS \qquad ( 2 )$$

where, the numerical value of the tensile strength TS (MPa) is substituted for TS in Formula (2).

The gist of the non-oriented electrical steel sheet of the present embodiment, which has been completed based on the technical idea described above, is as follows.

A non-oriented electrical steel sheet according to a first aspect consists of, in mass %, Si: 3.2 to 4.5%, Mn: 0.3 to 3.5%, sol. Al: 0.2 to 2.0%, C: 0.0010 to 0.0030%, N: more than 0% to 0.0050% or less, O: more than 0% to 0.0200% or less, P: more than 0% to 0.100% or less, S: more than 0% to 0.0030% or less, Ti: more than 0% to 0.0030% or less, Mo: 0 to 0.100%, Cr: 0 to 1.000%, Ni: 0 to 0.50%, Cu: 0 to 0.50%, B: 0 to 0.0010%, Zn: 0 to 0.0050%, Ga: 0 to 0.0050%, Ge: 0 to 0.0050%, As: 0 to 0.0100%, Sn: 0 to 0.20%, Sb: 0 to 0.10%, Ca: 0 to 0.0050%, La: 0 to 0.0050%, Ce: 0 to 0.0050%, Nd: 0 to 0.0010%, and Mg: 0 to 0.0030%, with the balance being Fe and impurities, and has a tensile strength TS that is higher than 580 MPa. Elemental analysis is performed by Auger electron spectroscopy in a grain boundary region of a fracture surface of the non-oriented electrical steel sheet to obtain Auger differential spectrum of Fe and P, and P₁₂₀/Fe₇₀₀ that is a ratio of a peak-to-peak value P₁₂₀ of P around an electron energy of 120 eV to a peak-to-peak value Fe₇₀₀ of Fe around an electron energy of 700 eV in the Auger differential spectrum obtained is defined as [P]_{GB}. Elemental analysis is performed by Auger electron spectroscopy in an intragranular region of a fracture surface of the non-oriented electrical steel sheet to obtain Auger differential spectrum of Fe and P, and P₁₂₀/Fe₇₀₀ that is a ratio of a peak-to-peak value P₁₂₀ of P around an electron energy of 120 eV to a peak-to-peak value Fe₇₀₀ of Fe around an electron energy of 700 eV in the Auger differential spectrum obtained is defined as [P]_{IG}. At this time, in the non-oriented electrical steel sheet, Formula (1) is satisfied. In the non-oriented electrical steel sheet, in addition, a difference ΔS between the tensile strength TS and a yield strength YP is 110 MPa or less, and an average grain size D (μm) satisfies Formula (2):

$${[ P ]}_{G B} {/ [ P ]}_{I G} > 2.0 \qquad ( 1 )$$

$$D \leq 100 - 15 \times {[ P ]}_{G B} {/ [ P ]}_{I G} + 1 \; 500 / TS \qquad ( 2 )$$

where, a numerical value of the tensile strength TS (MPa) is substituted for TS in Formula (2).

A non-oriented electrical steel sheet according to a second aspect is in accordance with the non-oriented electrical steel sheet according to the first aspect, wherein the non-oriented electrical steel sheet contains one or more types of element selected from a group consisting of, in mass %, Mo: 0.001 to 0.100%, Cr: 0.001 to 1.000%, Ni: 0.01 to 0.50%, Cu: 0.01 to 0.50%, B: 0.0001 to 0.0010%, Zn: 0.0001 to 0.0050%, Ga: 0.0001 to 0.0050%, Ge: 0.0001 to 0.0050%, As: 0.0001 to 0.0100%, Sn: 0.01 to 0.20%, Sb: 0.01 to 0.10%, Ca: 0.0001 to 0.0050%, La: 0.0001 to 0.0050%, Ce: 0.0001 to 0.0050%, Nd: 0.0001 to 0.0010%, and Mg: 0.0001 to 0.0030%.

A method for producing a non-oriented electrical steel sheet according to a first aspect is a method for producing the non-oriented electrical steel sheet according to the first or second aspect, and includes a hot rolling process, a cold rolling process, and a final annealing process. In the hot rolling process, a slab having a chemical composition according to the first or second aspect is subjected to hot rolling to produce a hot-rolled steel sheet. In the cold rolling process, the hot-rolled steel sheet is subjected to cold rolling to produce a cold-rolled steel sheet. In the final annealing process, the cold-rolled steel sheet is subjected to final annealing. In the final annealing process, the cold-rolled steel sheet is annealed at a highest temperature reached T1 of 950° C. or less, a tension TE1 applied to the cold-rolled steel sheet during annealing is set to 0.15 to 0.80 kgf/mm², an average cooling rate CR1 in a temperature range of 700 to 500° C. during cooling of the cold-rolled steel sheet after annealing is set to 20° C./sec or less, and a maximum tension TE2 applied to the cold-rolled steel sheet in a temperature range of 200° C. or less during cooling of the cold-rolled steel sheet after annealing is set to TE1+0.15 kgf/mm² or more and 0.40 kgf/mm² or more.

Hereunder, the non-oriented electrical steel sheet according to the present embodiment is described in detail.

### [Features of Non-Oriented Electrical Steel Sheet of Present Embodiment]

The non-oriented electrical steel sheet of the present embodiment satisfies the following feature 1 to feature 5.

### (Feature 1)

The chemical composition consists of, in mass %, Si: 3.2 to 4.5%, Mn: 0.3 to 3.5%, sol. Al: 0.2 to 2.0%, C: 0.0010 to 0.0030%, N: more than 0% to 0.0050% or less, O: more than 0% to 0.0200% or less, P: more than 0% to 0.100% or less, S: more than 0% to 0.0030% or less, Ti: more than 0% to 0.0030% or less, Mo: 0 to 0.100%, Cr: 0 to 1.000%, Ni: 0 to 0.50%, Cu: 0 to 0.50%, B: 0 to 0.0010%, Zn: 0 to 0.0050%, Ga: 0 to 0.0050%, Ge: 0 to 0.0050%, As: 0 to 0.0100%, Sn: 0 to 0.20%, Sb: 0 to 0.10%, Ca: 0 to 0.0050%, La: 0 to 0.0050%, Ce: 0 to 0.0050%, Nd: 0 to 0.0010%, and Mg: 0 to 0.0030%, with the balance being Fe and impurities.

### (Feature 2)

A tensile strength TS is higher than 580 MPa.

### (Feature 3)

Elemental analysis is performed by Auger electron spectroscopy in a grain boundary region of a fracture surface of the non-oriented electrical steel sheet to obtain Auger differential spectrum of Fe and P, and P₁₂₀/Fe₇₀₀ that is a ratio of a peak-to-peak value P₁₂₀ of P around an electron energy of 120 eV to a peak-to-peak value Fe₇₀₀ of Fe around an electron energy of 700 eV in the Auger differential spectrum obtained is defined as [P]_{GB}. Further, elemental analysis is performed by Auger electron spectroscopy in an intragranular region of a fracture surface of the non-oriented electrical steel sheet to obtain Auger differential spectrum of Fe and P, and P₁₂₀/Fe₇₀₀ that is a ratio of a peak-to-peak value P₁₂₀ of P around an electron energy of 120 eV to a peak-to-peak value Fe₇₀₀ of Fe around an electron energy of 700 eV in the Auger differential spectrum obtained is defined as [P]_{IG}. At this time, [P]_{GB} and [P]_{IG} satisfy Formula (1).

$${[ P ]}_{G B} {/ [ P ]}_{I G} > 2.0 \qquad ( 1 )$$

### (Feature 4)

A difference ΔS between the tensile strength TS and a yield strength YP is 110 MPa or less.

### (Feature 5)

An average grain size D (μm) satisfies Formula (2):

$$D \leq 100 - 15 \times {[ P ]}_{G B} {/ [ P ]}_{I G} + 1 \; 500 / TS \qquad ( 2 )$$

where, a numerical value of the tensile strength TS (MPa) is substituted for TS in Formula (2).

Feature 1 to feature 5 are described hereunder.

### [(Feature 1) Regarding Chemical Composition]

The chemical composition of the non-oriented electrical steel sheet of the present embodiment contains the following elements. Note that, the symbol “%” in regard to the chemical composition of the non-oriented electrical steel sheet means “mass percent” unless specifically stated otherwise.

### Si: 3.2 to 4.5%

Silicon (Si) increases the resistivity of the steel sheet and reduces eddy-current loss. Si also dissolves in the steel sheet and increases the strength of the non-oriented electrical steel sheet. If the content of Si is less than 3.2%, the aforementioned advantageous effects will not be sufficiently obtained. On the other hand, if the content of Si is more than 4.5%, the blanking workability of the non-oriented electrical steel sheet will decrease. Therefore, the content of Si is 3.2 to 4.5%.

A preferable lower limit of the content of Si is 3.3%, and more preferably is 3.4%.

A preferable upper limit of the content of Si is 4.4%, and more preferably is 4.3%.

### Mn: 0.3 to 3.5%

Manganese (Mn) increases the resistivity of the steel sheet and reduces eddy-current loss. If the content of Mn is less than 0.3%, the aforementioned advantageous effect will not be sufficiently obtained. On the other hand, if the content of Mn is more than 3.5%, the magnetic flux density of the steel will decrease. Therefore, the content of Mn is 0.3 to 3.5%.

A preferable lower limit of the content of Mn is 0.4%, and more preferably is 0.5%.

A preferable upper limit of the content of Mn is 3.4%, more preferably is 3.2%, and further preferably is 3.0%.

Sol. Al: 0.2 to 2.0%

Aluminum (sol. Al) increases the resistivity of the steel sheet and reduces eddy-current loss. If the content of sol. Al is less than 0.2%, the aforementioned advantageous effect will not be sufficiently obtained. On the other hand, if the content of sol. Al is more than 2.0%, the magnetic flux density of the steel will decrease. Therefore, the content of sol. Al is 0.2 to 2.0%.

A preferable lower limit of the content of sol. Al is 0.3%, and more preferably is 0.4%.

A preferable upper limit of the content of sol. Al is 1.5%, more preferably is 1.0%, and further preferably is 0.5%.

In the present description, the term “sol. Al” means “acid-soluble Al”.

### C: 0.0010 to 0.0030%

Carbon (C) fixes dislocations in the steel sheet and increases the yield strength. If the content of C is less than 0.0010%, the aforementioned advantageous effect will not be sufficiently obtained. On the other hand, if the content of C is more than 0.0030%, fine carbides will precipitate in the steel sheet and will cause a deterioration in iron loss. Therefore, the content of C is 0.0010 to 0.0030%.

A preferable lower limit of the content of C is 0.0012%, more preferably is 0.0014%, and further preferably is 0.0016%.

A preferable upper limit of the content of C is 0.0028%, more preferably is 0.0026%, and further preferably is 0.0024%.

N: More than 0% to 0.0050% or Less

Nitrogen (N) is unavoidably contained. That is, the content of N is more than 0%. N forms nitrides in the steel sheet and thereby causes a deterioration in iron loss. Therefore, the content of N is more than 0% to 0.0050% or less.

N is preferably as low as possible. However, excessively reducing the content of N will increase the production cost. Therefore, from the viewpoint of industrial productivity, a preferable lower limit of the content of N is 0.0001%, more preferably is 0.0005%, and further preferably is 0.0010%.

A preferable upper limit of the content of Nis 0.0040%, and more preferably is 0.0030%.

O: More than 0% to 0.0200% or Less

Oxygen (O) is unavoidably contained. That is, the content of O is more than 0%. O forms oxides in the steel sheet and causes a deterioration in iron loss and magnetic flux density. Therefore, the content of O is more than 0% to 0.0200% or less.

O is preferably as low as possible. However, excessively reducing the content of O will increase the production cost. Therefore, from the viewpoint of industrial productivity, a preferable lower limit of the content of O is 0.0001%, more preferably is 0.0005%, and further preferably is 0.0010%.

A preferable upper limit of the content of O is 0.0150%, and more preferably is 0.0100%.

P: More than 0% to 0.100% or Less

Phosphorus (P) is unavoidably contained. That is, the content of P is more than 0%. P increases the blanking workability of the high-strength non-oriented electrical steel sheet. However, if the content of P is more than 0.100%, the steel sheet will become brittle and the workability will decrease, and cracks may occur in the steel sheet during cold rolling. Therefore, the content of P is more than 0% to 0.100% or less.

P is preferably as low as possible. However, excessively reducing the content of P will increase the production cost. Therefore, from the viewpoint of industrial productivity, a preferable lower limit of the content of P is 0.001%, more preferably is 0.005%, further preferably is 0.008%, and further preferably is 0.010%.

A preferable upper limit of the content of P is 0.090%, more preferably is 0.080%, and further preferably is 0.070%.

S: More than 0% to 0.0030% or Less

Sulfur(S) is unavoidably contained. That is, the content of S is more than 0%. S forms MnS and thereby causes a deterioration in iron loss. Therefore, the content of S is more than 0% to 0.0030% or less.

The content of S is preferably as low as possible. However, excessively reducing the content of S will increase the production cost. Therefore, from the viewpoint of industrial productivity, a preferable lower limit of the content of S is 0.0001%, more preferably is 0.0003%, and further preferably is 0.0005%.

A preferable upper limit of the content of S is 0.0028%, more preferably is 0.0025%, further preferably is 0.0022%, and further preferably is 0.0020%.

Ti: More than 0% to 0.0030% or Less

Titanium (Ti) is unavoidably contained. That is, the content of Ti is more than 0%. Ti forms carbo-nitrides and increases the strength of the non-oriented electrical steel sheet by precipitation strengthening. However, if the content of Ti is more than 0.0030%, carbo-nitrides will excessively form and the magnetic properties will deteriorate. Therefore, the content of Ti is more than 0% to 0.0030% or less.

The content of Ti is preferably as low as possible. However, excessively reducing the content of Ti will increase the production cost. Therefore, a preferable lower limit of the content of Ti is 0.0001%, more preferably is 0.0003%, and further preferably is 0.0005%.

A preferable upper limit of the content of Ti is 0.0028%, more preferably is 0.0026%, and further preferably is 0.0024%.

The balance of the chemical composition of the non-oriented electrical steel sheet of the present embodiment is Fe and impurities. Here, the term “impurities” refers to substances which, when industrially producing the non-oriented electrical steel sheet, are mixed in from ore or scrap used as a raw material or from the production environment or the like. Contents of these impurities are allowed within a range that does not adversely affect the non-oriented electrical steel sheet of the present embodiment.

### [Optional Elements]

The chemical composition of the non-oriented electrical steel sheet of the present embodiment may further contain, in lieu of a part of Fe, one or more types of element selected from a group consisting of Mo: 0 to 0.100%, Cr: 0 to 1.000%, Ni: 0 to 0.50%, Cu: 0 to 0.50%, B: 0 to 0.0010%, Zn: 0 to 0.0050%, Ga: 0 to 0.0050%, Ge: 0 to 0.0050%, As: 0 to 0.0100%, Sn: 0 to 0.20%, Sb: 0 to 0.10%, Ca: 0 to 0.0050%, La: 0 to 0.0050%, Ce: 0 to 0.0050%, Nd: 0 to 0.0010%, and Mg: 0 to 0.0030%. These elements are described hereunder.

### [First Group: Mo, Cr, Ni, and Cu]

The chemical composition of the non-oriented electrical steel sheet of the present embodiment may further contain, in lieu of a part of Fe, one or more types of element selected from a group consisting of Mo: 0 to 0.100%, Cr: 0 to 1.000%, Ni: 0 to 0.50%, and Cu: 0 to 0.50%. Each of these elements increases the strength of the steel sheet.

### Mo: 0 to 0.100%

Molybdenum (Mo) is an optional element, and does not have to be contained. That is, the content of Mo may be 0%. When contained, in other words, when the content of Mo is more than 0%, Mo forms carbides and increases the strength of the non-oriented electrical steel sheet by precipitation strengthening. If even a small amount of Mo is contained, the aforementioned advantageous effect will be obtained to a certain extent.

However, if the content of Mo is more than 0.100%, carbides will excessively form and the magnetic properties will deteriorate. Therefore, the content of Mo is 0 to 0.100%.

A preferable lower limit of the content of Mo is 0.001%, more preferably is 0.005%, further preferably is 0.010%, and further preferably is 0.015%. A preferable upper limit of the content of Mo is 0.090%, more preferably is 0.080%, and further preferably is 0.070%.

### Cr: 0 to 1.000%

Chromium (Cr) is an optional element, and does not have to be contained. That is, the content of Cr may be 0%. When contained, in other words, when the content of Cr is more than 0%, Cr increases the strength of the non-oriented electrical steel sheet. Further Cr has high affinity for C. Therefore, in a temperature range (500 to 700° C.) in which P easily diffuses, Cr fixes C and thereby suppresses segregation of C to grain boundaries. As a result, segregation of P to the grain boundaries is facilitated. If even a small amount of Cr is contained, the aforementioned advantageous effect will be obtained to a certain extent.

However, if the content of Cr is more than 1.000%, the advantageous effect of Cr will be saturated. Therefore, the content of Cr is 0 to 1.000%.

A preferable lower limit of the content of Cr is 0.001%, more preferably is 0.005%, further preferably is 0.010%, further preferably is 0.015%, further preferably is 0.020%, further preferably is 0.050%, and further preferably is 0.100%.

A preferable upper limit of the content of Cr is 0.800%, more preferably is 0.600%, and further preferably is 0.550%.

### Ni: 0 to 0.50%

Nickel (Ni) is an optional element, and does not have to be contained. That is, the content of Ni may be 0%. When contained, in other words, when the content of Ni is more than 0%, Ni increases the strength of the non-oriented electrical steel sheet. If even a small amount of Ni is contained, the aforementioned advantageous effect will be obtained to a certain extent. However, if the content of Ni is more than 0.50%, the steel sheet will become brittle and the workability will decrease. Therefore, the content of Ni is 0 to 0.50%.

A preferable lower limit of the content of Ni is 0.01%, more preferably is 0.05%, and further preferably is 0.10%.

A preferable upper limit of the content of Ni is 0.45%, more preferably is 0.40%, and further preferably is 0.35%.

### Cu: 0 to 0.50%

Copper (Cu) is an optional element, and does not have to be contained. That is, the content of Cu may be 0%. When contained, in other words, when the content of Cu is more than 0%, Cu increases the strength of the non-oriented electrical steel sheet. If even a small amount of Cu is contained, the aforementioned advantageous effect will be obtained to a certain extent. However, if the content of Cu is more than 0.50%, the steel sheet will become brittle and workability will decrease. Therefore, the content of Cu is 0 to 0.50%.

A preferable lower limit of the content of Cu is 0.01%, more preferably is 0.05%, and further preferably is 0.10%.

A preferable upper limit of the content of Cu is 0.45%, more preferably is 0.40%, and further preferably is 0.35%.

### [Second Group: B, Zn, Ga, Ge, and As]

The chemical composition of the non-oriented electrical steel sheet of the present embodiment may further contain, in lieu of a part of Fe, one or more types of element selected from a group consisting of B: 0 to 0.0010%, Zn: 0 to 0.0050%, Ga: 0 to 0.0050%, Ge: 0 to 0.0050%, and As: 0 to 0.0100%.

### B: 0 to 0.0010%

Boron (B) is an optional element, and does not have to be contained. That is, the content of B may be 0%. When contained, in other words, when the content of B is more than 0%, B forms nitrides and inhibits recrystallization during final annealing. Therefore, the content of B is 0 to 0.0010%.

Excessively reducing the content of B will increase the production cost. Therefore, from the viewpoint of industrial productivity, a preferable lower limit of the content of B is 0.0001%, more preferably is 0.0002%, and further preferably is 0.0003%.

A preferable upper limit of the content of B is 0.0009%, more preferably is 0.0008%, and further preferably is 0.0007%.

### Zn: 0 to 0.0050%

Zinc (Zn) is an optional element, and does not have to be contained. That is, the content of Zn may be 0%. When contained, in other words, when the content of Zn is more than 0%, no particular problem occurs as long as the content of Zn is 0.0050% or less.

Excessively reducing the content of Zn will increase the production cost. Therefore, from the viewpoint of industrial productivity, a preferable lower limit of the content of Zn is 0.0001%, more preferably is 0.0002%, and further preferably is 0.0003%.

A preferable upper limit of the content of Zn is 0.0020%, more preferably is 0.0010%, and further preferably is 0.0005%.

### Ga: 0 to 0.0050%

Gallium (Ga) is an optional element, and does not have to be contained. That is, the content of Ga may be 0%. When contained, in other words, when the content of Ga is more than 0%, no particular problem occurs as long as the content of Ga is 0.0050% or less.

Excessively reducing the content of Ga will increase the production cost. Therefore, from the viewpoint of industrial productivity, a preferable lower limit of the content of Ga is 0.0001%, more preferably is 0.0002%, and further preferably is 0.0003%.

A preferable upper limit of the content of Ga is 0.0020%, more preferably is 0.0010%, and further preferably is 0.0005%.

### Ge: 0 to 0.0050%

Germanium (Ge) is an optional element, and does not have to be contained. That is, the content of Ge may be 0%. When contained, in other words, when the content of Ge is more than 0%, no particular problem occurs as long as the content of Ge is 0.0050% or less.

Excessively reducing the content of Ge will increase the production cost. Therefore, from the viewpoint of industrial productivity, a preferable lower limit of the content of Ge is 0.0001%, more preferably is 0.0002%, and further preferably is 0.0003%.

A preferable upper limit of the content of Ge is 0.0020%, more preferably is 0.0010%, and further preferably is 0.0005%.

### As: 0 to 0.0100%

Arsenic (As) is an optional element, and does not have to be contained. That is, the content of As may be 0%. When contained, in other words, when the content of As is more than 0%, no particular problem occurs as long as the content of As is 0.0100% or less.

Excessively reducing the content of As will increase the production cost. Therefore, from the viewpoint of industrial productivity, a preferable lower limit of the content of As is 0.0001%, more preferably is 0.0002%, and further preferably is 0.0003%.

A preferable upper limit of the content of As is 0.0070%, more preferably is 0.0050%, and further preferably is 0.0030%.

### [Third Group: Sn and Sb]

The chemical composition of the non-oriented electrical steel sheet of the present embodiment may further contain, in lieu of a part of Fe, one or more types of element selected from a group consisting of Sn: 0 to 0.20% and Sb: 0 to 0.10%. Each of these elements reduces iron loss of the non-oriented electrical steel sheet.

### Sn: 0 to 0.20%

Tin (Sn) is an optional element, and does not have to be contained. That is, the content of Sn may be 0%. When contained, in other words, when the content of Sn is more than 0%, Sn segregates to the surface of the steel sheet and suppresses oxidation and nitriding during final annealing. In addition, Sn improves the crystallographic texture of the steel sheet and thereby increases the magnetic flux density. As a result, iron loss of the non-oriented electrical steel sheet decreases. If even a small amount of Sn is contained, the aforementioned advantageous effects will be obtained to a certain extent. However, if the content of Sn is more than 0.20%, the steel sheet will become brittle and workability will decrease. Therefore, the content of Sn is 0 to 0.20%.

A preferable lower limit of the content of Sn is 0.01%, more preferably is 0.03%, and further preferably is 0.05%.

A preferable upper limit of the content of Sn is 0.18%, more preferably is 0.16%, and further preferably is 0.15%.

### Sb: 0 to 0.10%

Antimony (Sb) is an optional element, and does not have to be contained. That is, the content of Sb may be 0%. When contained, in other words, when the content of Sb is more than 0%, similarly to Sn, Sb segregates to the surface of the steel sheet and suppresses oxidation and nitriding during final annealing. In addition, Sb improves the crystallographic texture of the steel sheet and thereby increases the magnetic flux density. As a result, iron loss of the non-oriented electrical steel sheet decreases. If even a small amount of Sb is contained, the aforementioned advantageous effects will be obtained to a certain extent. However, if the content of Sb is more than 0.10%, the steel sheet will become brittle and workability will decrease. Therefore, the content of Sb is 0 to 0.10%.

A preferable lower limit of the content of Sb is 0.01%, and more preferably is 0.02%.

A preferable upper limit of the content of Sb is 0.08%, more preferably is 0.06%, and further preferably is 0.05%.

### [Fourth Group: Ca, La, Ce, Nd, and Mg]

The chemical composition of the non-oriented electrical steel sheet of the present embodiment may further contain, in lieu of a part of Fe, one or more types of element selected from a group consisting of Ca: 0 to 0.0050%, La: 0 to 0.0050%, Ce: 0 to 0.0050%, Nd: 0 to 0.0010%, and Mg: 0 to 0.0030%. Each of these elements promotes the growth of grains during final annealing.

### Ca: 0 to 0.0050%

Calcium (Ca) is an optional element, and does not have to be contained. That is, the content of Ca may be 0%. When contained, in other words, when the content of Ca is more than 0%, Ca combines with S during casting of molten steel and thereby forms coarse precipitates that are coarse sulfides and/or coarse oxysulfides. The grain size of the coarse precipitates is approximately 1 to 2 μm. The coarse sulfides adsorb fine inhibitors such as MnS, TiN, and AlN that have a grain size of approximately 100 nm which are formed in the steel sheet during the production process from the casting process onward. By this means, inhibition of grain growth by inhibitors is suppressed during final annealing. Consequently, the growth of grains is promoted during final annealing. As a result, the magnetic properties of the non-oriented electrical steel sheet are enhanced. If even a small amount of Ca is contained, the aforementioned advantageous effect will be obtained to a certain extent.

However, if the content of Ca is more than 0.0050%, coarse precipitates will excessively form. In such case, recrystallization and the growth of grains will be inhibited during the final annealing process. Therefore, the content of Ca is 0 to 0.0050%.

A preferable lower limit of the content of Ca is 0.0001%, more preferably is 0.0005%, and further preferably is 0.0010%.

A preferable upper limit of the content of Ca is 0.0045%, more preferably is 0.0040%, and further preferably is 0.0035%.

### La: 0 to 0.0050%

Lanthanum (La) is an optional element, and does not have to be contained. That is, the content of La may be 0%. When contained, in other words, when the content of La is more than 0%, similarly to Ca, La forms coarse precipitates and thereby suppresses inhibition of the growth of grains by inhibitors during final annealing. Consequently, the growth of grains is promoted during final annealing. As a result, the magnetic properties of the non-oriented electrical steel sheet are enhanced. If even a small amount of La is contained, the aforementioned advantageous effect will be obtained to a certain extent.

However, if the content of La is more than 0.0050%, coarse precipitates will excessively form. In such case, recrystallization and the growth of grains will be inhibited during the final annealing process. Therefore, the content of La is 0 to 0.0050%.

A preferable lower limit of the content of La is 0.0001%, more preferably is 0.0005%, and further preferably is 0.0010%.

A preferable upper limit of the content of La is 0.0045%, more preferably is 0.0040%, and further preferably is 0.0035%.

### Ce: 0 to 0.0050%

Cerium (Ce) is an optional element, and does not have to be contained. That is, the content of Ce may be 0%. When contained, in other words, when the content of Ce is more than 0%, similarly to Ca, Ce forms coarse precipitates and thereby suppresses inhibition of the growth of grains by inhibitors during final annealing. Consequently, the growth of grains is promoted during final annealing. As a result, the magnetic properties of the non-oriented electrical steel sheet are enhanced. If even a small amount of Ce is contained, the aforementioned advantageous effect will be obtained to a certain extent.

However, if the content of Ce is more than 0.0050%, coarse precipitates will excessively form. In such case, recrystallization and the growth of grains will be inhibited during the final annealing process. Therefore, the content of Ce is 0 to 0.0050%.

A preferable lower limit of the content of Ce is 0.0001%, more preferably is 0.0005%, and further preferably is 0.0010%.

A preferable upper limit of the content of Ce is 0.0045%, more preferably is 0.0040%, and further preferably is 0.0035%.

### Nd: 0 to 0.0010%

Neodymium (Nd) is an optional element, and does not have to be contained. That is, the content of Nd may be 0%. When contained, in other words, when the content of Nd is more than 0%, similarly to Ca, Nd forms coarse precipitates and thereby suppresses inhibition of the growth of grains by inhibitors during final annealing. Consequently, the growth of grains is promoted during final annealing. As a result, the magnetic properties of the non-oriented electrical steel sheet are enhanced. If even a small amount of Nd is contained, the aforementioned advantageous effect will be obtained to a certain extent.

However, if the content of Nd is more than 0.0010%, coarse precipitates will excessively form. In such case, recrystallization and the growth of grains will be inhibited during the final annealing process. Therefore, the content of Nd is 0 to 0.0010%

A preferable lower limit of the content of Nd is 0.0001%, more preferably is 0.0002%, and further preferably is 0.0003%.

A preferable upper limit of the content of Nd is 0.0008%, more preferably is 0.0006%, and further preferably is 0.0004%.

### Mg: 0 to 0.0030%

Magnesium (Mg) is an optional element, and does not have to be contained. That is, the content of Mg may be 0%. When contained, in other words, when the content of Mg is more than 0%, similarly to Ca, Mg forms coarse precipitates and thereby suppresses inhibition of the growth of grains by inhibitors during final annealing. Consequently, the growth of grains is promoted during final annealing. As a result, the magnetic properties of the non-oriented electrical steel sheet are enhanced. If even a small amount of Mg is contained, the aforementioned advantageous effect will be obtained to a certain extent.

However, if the content of Mg is more than 0.0030%, coarse precipitates will excessively form. In such case, recrystallization and the growth of grains will be inhibited during the final annealing process. Therefore, the content of Mg is 0 to 0.0030%.

A preferable lower limit of the content of Mg is 0.0001%, more preferably is 0.0002%, and further preferably is 0.0003%.

A preferable upper limit of the content of Mg is 0.0020%, more preferably is 0.0015%, and further preferably is 0.0010%.

### [Method for Measuring Chemical Composition of Non-Oriented Electrical Steel Sheet]

The chemical composition of the non-oriented electrical steel sheet of the present embodiment can be measured by a well-known composition analysis method in accordance with JIS G0321: 2017. Specifically, a drill is used to collect a machined chip from the steel sheet. The collected machined chip is dissolved in acid to obtain a liquid solution. The liquid solution is subjected to ICP-AES (Inductively Coupled Plasma Atomic Emission Spectrometry) to perform elemental analysis of the chemical composition. The content of C and the content of S are determined by a well-known high-frequency combustion method (combustion-infrared absorption method). The content of N is determined using a well-known inert gas fusion-thermal conductivity method. The content of O is determined using a well-known inert gas fusion-infrared absorption method.

Note that, the content of each element is taken as a numerical value up to the least significant digit of the content of each element defined in the present embodiment that is obtained by rounding off a fraction of the measured numerical value based on the significant figures defined in the present embodiment. Note that, the term “rounding off” means rounding down if the fraction is less than 5, and rounding up if the fraction is 5 or more.

### [(Feature 2) Tensile Strength TS]

In the non-oriented electrical steel sheet of the present embodiment, the tensile strength TS is higher than 580 MPa. That is, the non-oriented electrical steel sheet of the present embodiment has high strength.

A preferable lower limit of the tensile strength TS of the non-oriented electrical steel sheet of the present embodiment is 585 MPa, and more preferably is 590 MPa.

The upper limit of the tensile strength TS is not particularly limited. However, in a case where feature 1 is satisfied, the upper limit of the tensile strength TS is, for example, 850 MPa.

### [Method for Measuring Tensile Strength TS and Yield Strength YP]

The tensile strength TS and the yield strength YP of the non-oriented electrical steel sheet of the present embodiment are measured by the following method. A JIS No. 5 tensile test coupon defined in JIS Z 2241 (2011) is taken from the non-oriented electrical steel sheet. The taken tensile test specimen is used to carry out a tensile test at normal temperature in the atmosphere in accordance with JIS Z 2241:2011 to determine the yield strength YP (MPa) and the tensile strength TS (MPa). Note that, in the non-oriented electrical steel sheet of the present embodiment, the grains are fine grains which are fine enough for the average grain size D to satisfy feature 5. Therefore, an upper yield point can be observed in a stress-strain curve obtained by the aforementioned tensile test. Therefore, the yield strength YP is taken as the upper yield point.

### [(Feature 3) Amount of P Segregation at Grain Boundaries]

In the non-oriented electrical steel sheet of the present embodiment, [P]_{GB} that is an index of the P concentration at the grain boundaries, and [P]_{IG} that is an index of the P concentration within the grains are defined as follows.

### [P]_{GB}:

A grain boundary region of a fracture surface of the non-oriented electrical steel sheet is analyzed by Auger electron spectroscopy, and Auger differential spectrum are obtained. In the obtained Auger differential spectrum, a peak-to-peak value of Fe around an electron energy of 700 eV is defined as Fe₇₀₀. Further, a peak-to-peak value of P around an electron energy of 120 eV is defined as P₁₂₀. P₁₂₀/Fe₇₀₀ that is a ratio of P₁₂₀ to Fe₇₀₀ is defined as [P]_{GB}.

### [P]_{IG}:

An intragranular region of a fracture surface of the non-oriented electrical steel sheet is analyzed by Auger electron spectroscopy, and Auger differential spectrum are obtained. In the obtained Auger differential spectrum, a peak-to-peak value of Fe around an electron energy of 700 eV is defined as Fe₇₀₀. Further, a peak-to-peak value of P around an electron energy of 120 eV is defined as P₁₂₀. P₁₂₀/Fe₇₀₀ that is a ratio of P₁₂₀ to Fe₇₀₀ is defined as [P]_{IG}.

Note that, the phrase “around EN (eV)” (EN is a numerical value of electron energy) means within a range of EN±5%. Further, the phrase “peak-to-peak value of P” means the value of the difference between the maximum peak and the minimum peak of P around EN (eV). The phrase “peak-to-peak value of Fe” means the value of the difference between the maximum peak and the minimum peak of Fe around EN (eV).

[P]_{GB} and [P]_{IG} that are defined as described above satisfy the following Formula (1).

$${[ P ]}_{G B} {/ [ P ]}_{I G} > 2.0 \qquad ( 1 )$$

[P]_{GB}/[P]_{IG} means a ratio of the P concentration at the grain boundaries to the P concentration within the grains in the non-oriented electrical steel sheet. That is, [P]_{GB}/[P]_{IG} is an index of the amount of P segregation to the grain boundaries. In the non-oriented electrical steel sheet of the present embodiment, the amount of P segregation at the grain boundaries is increased to make [P]_{GB}/[P]_{IG} higher than 2.0. By this means, the occurrence of grain boundary fracturing during blanking is facilitated. As a result, excellent blanking workability is obtained.

A preferable lower limit of [P]_{GB}/[P]_{IG} is 2.1, more preferably is 2.2, further preferably is 2.3, and further preferably is 2.5.

A preferable upper limit of [P]_{GB}/[P]_{IG} is 5.0. In this case, an appropriate amount of grain boundary fracturing occurs during blanking. Therefore, further excellent blanking workability is obtained. A more preferable upper limit of [P]_{GB}/[P]_{IG} is 4.9, and further preferably is 4.8.

[Method for Measuring [P]_{GB} and [P]_{IG}]

[P]_{GB} and [P]_{IG} can be measured by the following method. A plurality of rough test specimens with dimensions of 18 mm in L×4 mm in W×a sheet thickness of T (L means the length in the rolling elongation direction, W means the sheet width, and T means the sheet thickness) are taken from the non-oriented electrical steel sheet. The rough test specimens are notched in the center in the longitudinal direction to form a notch extending in the sheet width direction. The prepared test specimens are used as test specimens for Auger electron spectroscopy peak measurement.

Each test specimen for Auger electron spectroscopy peak measurement is placed in an Auger electron spectrometer, and the test specimen is cooled with liquid nitrogen. After being cooled, the test specimen is fractured to form a fracture surface on the test specimen. Using a scanning electron microscope (SEM), on the obtained fracture surface, observation regions at an arbitrary 10 locations are observed at a magnification of 2000× to 10000×, and one grain boundary fracture surface and one intragranular fracture surface are selected in each observation region.

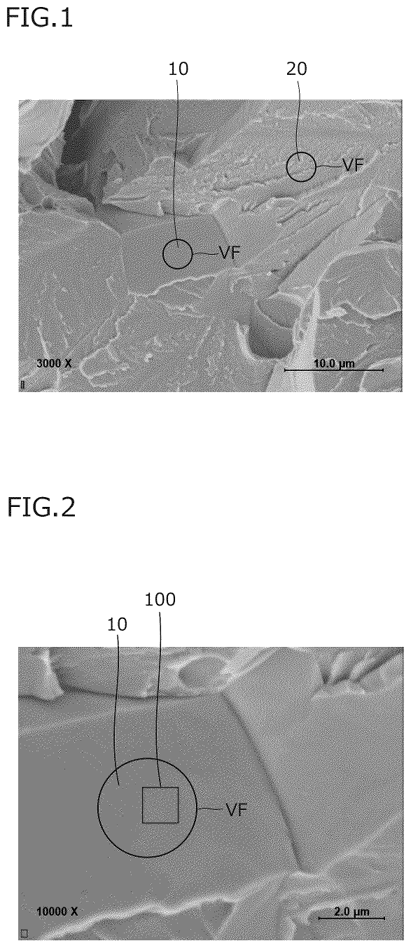

FIG. 1 is an example of an SEM image obtained by observation at a magnification of 3000× using an SEM. Referring to FIG. 1, when a circular determination visual field VF having a diameter of 3 μm is arranged in the observation region, a region 10 (corresponding to a cleavage fracture surface) in which a river pattern is not observed in the determination visual field VF is determined as being a grain boundary region 10. On the other hand, a region 20 in which a river pattern is observed in the determination visual field VF is determined as being an intragranular region 20.

When determining the determination visual field VF as being a grain boundary region 10, a region in which a river pattern is substantially not observed in the entire determination visual field FV (that is, a region in which a pattern is not observed and which is substantially smooth overall) is selected. Similarly, when determining the determination visual field VF as being an intragranular region 20, a region in which a river pattern is uniformly observed in the entire determination visual field FV (that is, a region in which a river pattern is substantially present overall, without a smooth region and a region in which a river pattern is present intermixing with each other) is selected.

One grain boundary region and one intragranular region selected in each observation region are subjected to elemental analysis by Auger electron spectroscopy. Specifically, as shown in FIG. 2, elemental analysis is performed on an arbitrary measurement region 100 with dimensions of 1.0 μm×1.0 μm in the determination visual field VF determined as being the grain boundary region 10 to thereby obtain Auger-electron differential spectra of P and Fe.

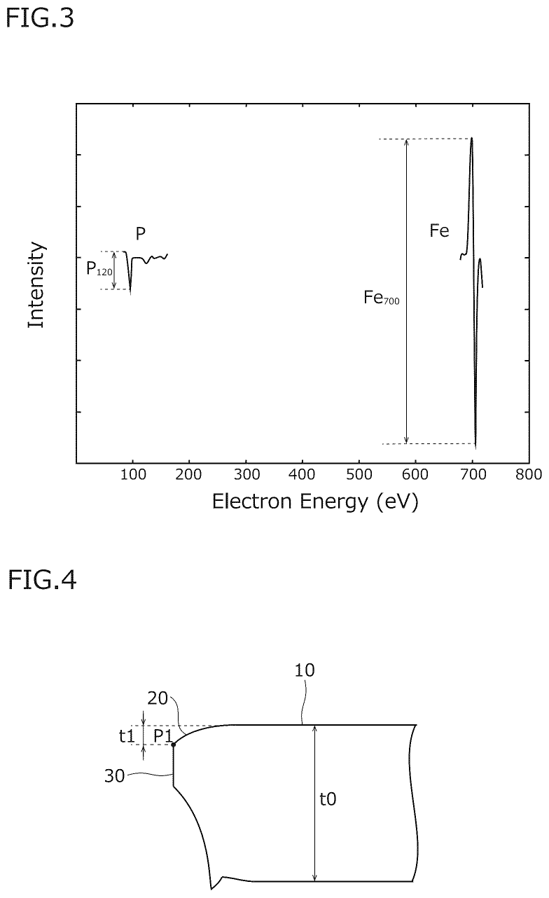

An example of the obtained Auger-electron differential spectra is shown in FIG. 3. In the Auger-electron differential spectra, the main peak of Fe appears when the electron energy is around 700 eV. Therefore, the peak-to-peak value, which is the difference between the maximum peak and the minimum peak of Fe around 700 eV, is defined as Fe₇₀₀. Further, in the Auger-electron differential spectra, the main peak of P appears when the electron energy is around 120 eV. Therefore, the peak-to-peak value of P around 120 eV is defined as P₁₂₀. P₁₂₀/Fe₇₀₀ is then determined based on the obtained Fe₇₀₀ and P₁₂₀. P₁₂₀/Fe₇₀₀ is determined for the grain boundary fracture surface in each observation region. Then, the arithmetic average value of the determined 10 values of P₁₂₀/Fe₇₀₀ is defined as [P]_{GB}.

Similarly, elemental analysis is performed on an arbitrary measurement region with dimensions of 1.0 μm×1.0 μm in the determination visual field VF determined as being the intragranular region 20 in each observation region to thereby obtain Auger-electron differential spectra of P and Fe. P₁₂₀/Fe₇₀₀ is then determined based on the obtained Auger-electron differential spectra. P₁₂₀/Fe₇₀₀ is determined for the intragranular region in each observation region. Then, the arithmetic average value of the obtained 10 values of P₁₂₀/Fe₇₀₀ is defined as [P]_{IG}.

Note that, in the elemental analysis by Auger electron spectroscopy, the primary beam acceleration voltage is set to 10 kV.

### [(Feature 4) Regarding Difference Between Tensile Strength TS and Yield Strength YP]

In the non-oriented electrical steel sheet of the present embodiment, in addition, the difference ΔS between the tensile strength TS and the yield strength YP is 110 MPa or less.

The smaller the difference ΔS, the more plastic deformation leading to fracture can be suppressed. In this case, the shear droop amount during blanking can be reduced. As a result, excellent blanking workability is obtained. In the present embodiment, strain aging by C is promoted while also increasing the amount of P segregation to the grain boundaries. By this means, the upper yield point in the stress-strain curve of the non-oriented electrical steel sheet is increased, thereby increasing the yield strength YP. As a result, the difference ΔS between the tensile strength TS and the yield strength YP is suppressed to 110 MPa or less.

A preferable upper limit of the difference ΔS is 105 MPa, more preferably is 100 MPa, further preferably is 95 MPa, and further preferably is 90 MPa.

### [(Feature 5) Regarding Average Grain Size D]

In the non-oriented electrical steel sheet of the present embodiment, in addition, the average grain size D satisfies Formula (2):

$$D \leq 100 - 15 \times {[ P ]}_{G B} {/ [ P ]}_{I G} + 1 \; 500 / TS \qquad ( 2 )$$

where, a numerical value of the tensile strength TS (MPa) is substituted for TS in Formula (2).

If a non-oriented electrical steel sheet satisfies feature 1 to feature 4, excellent blanking workability will be obtained even though the non-oriented electrical steel sheet has high strength. However, in a non-oriented electrical steel sheet that satisfies feature 1 to feature 4, in some cases toughness may decrease due to embrittlement. The higher the value of [P]_{GB}, which indicates the amount of P segregation at grain boundaries of the non-oriented electrical steel sheet, and the higher the tensile strength TS of the non-oriented electrical steel sheet, the more likely the toughness of the non-oriented electrical steel sheet is to decrease. Therefore, in the non-oriented electrical steel sheet of the present embodiment, the average grain size D is to be made a size that corresponds to [P]_{GB}/[P]_{IG} and the tensile strength TS. Here, FN is defined as follows.

$$FN = 100 - 15 \times {[ P ]}_{G B} {/ [ P ]}_{I G} + 1 \; 500 / TS$$

If the average grain size D is equal to or less than FN, the average grain size D is sufficiently small relative to [P]_{GB}/[P]_{IG} and the tensile strength TS. Therefore, excellent toughness is obtained.

### [Method for Measuring Average Grain Size D]

The average grain size D is determined by the following method. A cross section (L cross section) parallel to the rolling elongation direction of the non-oriented electrical steel sheet is adopted as an observation surface. The observation surface is mirror-polished, and thereafter the mirror-polished observation surface is subjected to etching using a nital solution. An arbitrary three locations on the etched observation surface are observed at a magnification of 100× using an optical microscope, and photographic images of the observation fields are generated. When the thickness of the non-oriented electrical steel sheet is taken as “t (mm)”, each observation field is a rectangle constituted by sides in the thickness direction and sides in the rolling elongation direction, and has dimensions of t mm×t mm. Using the photographic images, the average grain size (μm) in each visual field area is determined by an intercept method in accordance with JIS G 0551:2013 “Steels-Micrographic determination of the apparent grain size.” The arithmetic average value of the three average grain sizes obtained is defined as the average grain size D (μm).

### [Regarding Advantageous Effects of Non-Oriented Electrical Steel Sheet of Present Embodiment]

The non-oriented electrical steel sheet of the present embodiment satisfies feature 1 to feature 5. Therefore, in the non-oriented electrical steel sheet of the present embodiment, excellent blanking workability is obtained even though the non-oriented electrical steel sheet has high strength. In addition, in the non-oriented electrical steel sheet of the present embodiment, excellent toughness is also obtained.

### [Method for Producing Non-Oriented Electrical Steel Sheet]

One example of a method for producing the non-oriented electrical steel sheet of the present embodiment will now be described. A method for producing the non-oriented electrical steel sheet of the present embodiment includes the following processes.
(Process 1) Hot rolling process
(Process 2) Hot-rolled sheet annealing process
(Process 3) Cold rolling process
(Process 4) Final annealing process

Note that, the hot-rolled sheet annealing process is an optional process. That is, the hot-rolled sheet annealing process may be omitted. Hereunder, each process is described.

### [(Process 1) Hot Rolling Process]

In the hot rolling process, a slab is subjected to hot rolling to produce a hot-rolled steel sheet. The slab has the chemical composition described above. The slab is produced by a well-known method. For example, the slab is produced by a continuous casting process using molten metal.

The prepared slab is subjected to hot rolling. The various conditions in the hot rolling are not particularly limited. The respective production conditions during the hot rolling are not particularly limited. The slab heating temperature is, for example, 1000° C. to 1300° C. The rolling finishing temperature is, for example, 800 to 1100° C. The coiling temperature is, for example, 500 to 800° C.

### [(Process 2) Hot-Rolled Sheet Annealing Process]

The hot-rolled sheet annealing process is an optional process. That is, the hot-rolled sheet annealing process may be performed, or need not be performed. When performed, in the hot-rolled sheet annealing process, annealing of the hot-rolled steel sheet is performed. The hot-rolled sheet annealing may be box annealing or may be continuous annealing. The annealing conditions in the hot-rolled sheet annealing process are not particularly limited. The annealing temperature is, for example, 900 to 1100° C. The annealing time is, for example, one second to 10 hours. Note that, as necessary, a well-known pickling treatment may be performed on the steel sheet before performing annealing in the hot-rolled sheet annealing process, and/or on the steel sheet after annealing is performed.

### [(Process 3) Cold Rolling Process]

In the cold rolling process, the hot-rolled steel sheet produced in the hot rolling process or the hot-rolled steel sheet after the hot-rolled sheet annealing process is subjected to cold rolling to produce a cold-rolled steel sheet. The cold rolling may be performed only one time or may be performed multiple times. In the case of performing cold rolling multiple times, intermediate annealing may be performed at a timing after one cold rolling operation is performed and before the next cold rolling operation is performed.

### [(Process 4) Final Annealing Process]

The cold-rolled steel sheet produced by performing the final annealing process is subjected to final annealing to produce a non-oriented electrical steel sheet. In the final annealing, the cold rolled steel sheet finished to the final sheet thickness is annealed to cause recrystallization and grain growth. The final annealing is performed using a continuous annealing furnace equipped with, in the direction from upstream to downstream, a heating zone, a soaking zone, and a cooling zone. Note that, the continuous annealing furnace may also be equipped with, downstream of the cooling zone, apparatus that applies an insulating coating and dries the coating. In the final annealing process, the following condition 1 to condition 4 are satisfied.

### (Condition 1)

Anneal at a highest temperature reached T1 of 950° C. or less.

### (Condition 2)

A tension TE1 applied to the cold-rolled steel sheet during annealing is to be 0.15 to 0.80 kgf/mm².

### (Condition 3)

During cooling after annealing, an average cooling rate CR1 in a temperature range from 700 to 500° C. is to be 20° C./sec or less.

### (Condition 4)

During cooling after annealing, a maximum tension TE2 applied to the cold-rolled steel sheet in a temperature range of 200° C. or less is to be TE1+0.15 kgf or more and 0.40 kgf/mm² or more.

Condition 1 to condition 4 are described hereunder.

### [(Condition 1) Regarding Highest Temperature Reached T1]

The highest temperature reached T1 is to be 950° C. or less. If the highest temperature reached T1 is more than 950° C., the grain boundary migration rate during grain growth will increase and the amount of segregation of P to grain boundaries will decrease due to a drag effect. There will also be an effect such that grains will become excessively coarse and the average grain size D will no longer satisfy Formula (2). Therefore, the highest temperature reached T1 is 950° C. or less. It suffices that the lower limit of the highest temperature reached T1 is a well-known temperature. The lower limit of the highest temperature reached T1 is, for example, 800° C.

### [(Condition 2) Regarding Tension TE1 During Final Annealing]

The tension TE1 applied to the cold-rolled steel sheet during the final annealing suppresses meandering of the traveling steel sheet. If the tension TE1 is 0.15 kgf/mm² or more, meandering of the traveling steel sheet can be sufficiently suppressed.

On the other hand, if the tension TE1 is too high, in some cases the strain introduced into the steel sheet during annealing at high temperature may remain, which will result in a deterioration in iron loss. Furthermore, the difference ΔS between the tensile strength TS and the yield strength YP of the non-oriented electrical steel sheet will be more than 110 MPa. Therefore, the upper limit of the tension TE1 is to be 0.80 kgf/cm². A preferable upper limit of the tension TE1 is 0.50 kgf/mm², and more preferably is 0.35 kgf/mm².

### [(Condition 3) Regarding Average Cooling Rate CR1]

In the final annealing process, the cold-rolled steel sheet after the final annealing is cooled. The temperature range of 700 to 500° C. during cooling is a temperature range in which P is likely to diffuse and segregate to the grain boundaries. Therefore, the cooling rate from 700 to 500° C. is made as slow as possible to thereby lengthen the residence time in the temperature range of 700 to 500° C. By this means, P is allowed to sufficiently diffuse to the grain boundaries to thereby increase the amount of P segregation at the grain boundaries.

If the average cooling rate CR1 is 20° C./sec or less, the cooling rate from 700 to 500° C. will be sufficiently slow and a sufficient residence time in the temperature range of 700 to 500° C. can be secured. As a result, [P]_{GB}/[P]_{IG} will be higher than 2.0.

### [(Condition 4) Regarding Maximum Tension TE2 in Temperature Range of 200° C. Or Less]

In the cooling zone of a continuous annealing furnace, a plurality of bridle rolls and transfer rolls are arranged. A region from the cooling zone onwards is divided into a plurality of zones in the direction from upstream to downstream. The plurality of bridle rolls are arranged so that different tensions can be applied to the cold-rolled steel sheet in the respective zones. Note that, the tension of the steel sheet before and after the transfer rolls can be changed (adjusted) not only by the bridle rolls, but also by the transfer rolls in the cooling zone.

During cooling after the final annealing, a maximum tension TE2 among one or a plurality of tensions applied to the cold-rolled steel sheet in a plurality of zones in a temperature range of 200° C. or less is to be TE1+0.15 kgf/mm² or more and 0.40 kgf/mm² or more. In the temperature range of 200° C. or less, P, which is a substitutional element, does not move, but C, which is an interstitial element, moves. Therefore, if a high tension can be applied to the cold-rolled steel sheet in the temperature range of 200° C. or less, dissolved C will adhere to dislocations introduced by the tension. By this means, strain aging of C can be further promoted.

Therefore, the maximum tension TE2 applied to the cold-rolled steel sheet in the temperature range of 200° C. or less is to be TE1+0.15 kgf/mm² or more and 0.40 kgf/mm² or more. In this case, strain aging of C can be sufficiently promoted. As a result, the difference ΔS between the tensile strength TS and the yield strength YP of the non-oriented electrical steel sheet will be 110 MPa or less.

Note that, as mentioned above, it is not necessary for all of the tensions in all of the periods (zones) in the temperature range of 200° C. or less to be TE1+0.15 kgf/mm² or more and 0.40 kgf/mm² or more. It suffices that the maximum tension TE2 applied in at least one part of the periods (zones) in the temperature range of 200° C. or less is TE1+0.15 kgf/mm² or more and 0.40 kgf/mm² or more. Therefore, the highest value of the tension TE2 applied to the cold-rolled steel sheet in the temperature range of 200° C. or less is to be TE1+0.15 kgf/mm² or more and 0.40 kgf/mm² or more.

Further, although the upper limit of the maximum tension TE2 is not particularly limited, taking into consideration normal equipment capacity, the upper limit of the maximum tension TE2 is 1.00 kgf/mm².

### [Other Process]

In the production method described above, a coating process may be performed after the final annealing process. In the coating process, an insulating coating is applied to the surface of the non-oriented electrical steel sheet after the final annealing. The type of insulating coating is not particularly limited. The insulating coating may be composed of organic components, inorganic components, or a mixture of organic components and inorganic components.

The non-oriented electrical steel sheet of the present embodiment can be produced by the production method described above. Note that, a method for producing the non-oriented electrical steel sheet of the present embodiment is not particularly limited as long as the non-oriented electrical steel sheet satisfies feature 1 to feature 5.

### Example 1

Non-oriented electrical steel sheets having the chemical compositions shown in Table 1-1 and Table 1-2 were produced by the following method.

TABLE 1-1

| | Chemical Composition (unit is mass %; balance is Fe and impurities) | | | | | | | | | | |
|---|---|---|---|---|---|---|---|---|---|---|---|
| Test Number | Si | Mn | sol-Al | C | N | O | P | S | Ti | Mo | Cr |
| 1 | 3.6 | 0.3 | 0.2 | 0.0012 | 0.0032 | 0.0056 | 0.064 | 0.0015 | 0.0015 | — | — |
| 2 | 3.2 | 0.3 | 0.6 | 0.0014 | 0.0026 | 0.0012 | 0.013 | 0.0016 | 0.0005 | — | — |
| 3 | 3.5 | 0.7 | 0.6 | 0.0015 | 0.0022 | 0.0011 | 0.041 | 0.0014 | 0.0010 | — | — |
| 4 | 3.9 | 1.2 | 0.2 | 0.0013 | 0.0015 | 0.0027 | 0.014 | 0.0016 | 0.0020 | 0.014 | — |
| 5 | 3.8 | 1.2 | 0.4 | 0.0012 | 0.0013 | 0.0094 | 0.015 | 0.0012 | 0.0008 | — | 0.037 |
| 6 | 3.4 | 0.5 | 0.6 | 0.0023 | 0.0017 | 0.0026 | 0.011 | 0.0009 | 0.0009 | — | 0.003 |
| 7 | 3.7 | 0.3 | 0.2 | 0.0013 | 0.0011 | 0.0011 | 0.008 | 0.0016 | 0.0019 | — | — |
| 8 | 3.3 | 0.9 | 1.1 | 0.0011 | 0.0014 | 0.0088 | 0.049 | 0.0010 | 0.0013 | — | — |
| 9 | 3.2 | 1.2 | 0.2 | 0.0012 | 0.0012 | 0.0018 | 0.054 | 0.0010 | 0.0009 | — | — |
| 10 | 3.7 | 1.3 | 0.4 | 0.0011 | 0.0034 | 0.0011 | 0.019 | 0.0022 | 0.0010 | — | — |
| 11 | 3.2 | 0.9 | 0.2 | 0.0014 | 0.0033 | 0.0014 | 0.047 | 0.0019 | 0.0010 | — | — |
| 12 | 4 | 0.4 | 0.3 | 0.0018 | 0.0033 | 0.0019 | 0.013 | 0.0019 | 0.0011 | — | — |
| 13 | 4.1 | 0.4 | 0.4 | 0.0028 | 0.0010 | 0.0016 | 0.007 | 0.0028 | 0.0008 | — | — |
| 14 | 3.8 | 0.4 | 0.5 | 0.0027 | 0.0032 | 0.0165 | 0.017 | 0.0010 | 0.0025 | — | — |
| 15 | 3.9 | 0.8 | 0.3 | 0.0012 | 0.0037 | 0.0026 | 0.021 | 0.0022 | 0.0008 | — | — |
| 16 | 3.9 | 0.3 | 0.5 | 0.0014 | 0.0011 | 0.0126 | 0.017 | 0.0010 | 0.0011 | — | — |
| 17 | 3.7 | 1.5 | 0.4 | 0.0030 | 0.0019 | 0.0029 | 0.023 | 0.0011 | 0.0014 | — | — |
| 18 | 3.3 | 0.3 | 0.9 | 0.0012 | 0.0013 | 0.0179 | 0.071 | 0.0022 | 0.0023 | — | — |
| 19 | 3.2 | 0.6 | 0.9 | 0.0016 | 0.0011 | 0.0010 | 0.024 | 0.0015 | 0.0008 | — | — |
| 20 | 3.2 | 0.5 | 0.6 | 0.0020 | 0.0013 | 0.0017 | 0.082 | 0.0011 | 0.0014 | — | — |
| 21 | 3.3 | 1.0 | 0.6 | 0.0023 | 0.0023 | 0.0037 | 0.010 | 0.0013 | 0.0022 | 0.015 | 0.031 |
| 22 | 3.7 | 0.9 | 0.3 | 0.0020 | 0.0013 | 0.0123 | 0.015 | 0.0005 | 0.0013 | 0.063 | 0.034 |
| 23 | 3.5 | 3.2 | 0.5 | 0.0018 | 0.0018 | 0.0077 | 0.008 | 0.0013 | 0.0017 | 0.003 | 0.051 |
| 24 | 4.3 | 0.4 | 0.2 | 0.0017 | 0.0045 | 0.0096 | 0.008 | 0.0021 | 0.0006 | 0.043 | 0.120 |
| 25 | 3.4 | 0.3 | 1.8 | 0.0019 | 0.0035 | 0.0190 | 0.011 | 0.0020 | 0.0005 | 0.092 | 0.513 |
| 26 | 3.3 | 0.5 | 0.3 | 0.0024 | 0.0015 | 0.0022 | 0.042 | 0.0010 | 0.0006 | 0.008 | 0.080 |
| 27 | 3.8 | 1.4 | 0.7 | 0.0025 | 0.0011 | 0.0073 | 0.023 | 0.0013 | 0.0016 | 0.074 | 0.041 |
| 28 | 3.3 | 2.1 | 1.1 | 0.0021 | 0.0026 | 0.0131 | 0.008 | 0.0005 | 0.0005 | 0.082 | 0.055 |
| 29 | 4.1 | 0.9 | 0.2 | 0.0023 | 0.0013 | 0.0014 | 0.007 | 0.0019 | 0.0005 | 0.083 | 0.041 |
| 30 | 3.5 | 0.5 | 0.4 | 0.0026 | 0.0017 | 0.0107 | 0.081 | 0.0005 | 0.0020 | 0.092 | 0.053 |
| 31 | 3.6 | 0.3 | 0.5 | 0.0018 | 0.0037 | 0.0135 | 0.021 | 0.0009 | 0.0008 | 0.007 | 0.051 |
| 32 | 3.8 | 1.2 | 0.4 | 0.0014 | 0.0011 | 0.0100 | 0.022 | 0.0015 | 0.0005 | 0.009 | 0.031 |
| 33 | 3.3 | 0.4 | 0.8 | 0.0019 | 0.0013 | 0.0034 | 0.013 | 0.0019 | 0.0005 | 0.072 | 0.037 |
| 34 | 3.2 | 0.7 | 0.6 | 0.0024 | 0.0031 | 0.0018 | 0.011 | 0.0009 | 0.0018 | 0.015 | 0.083 |
| 35 | 3.5 | 0.6 | 0.6 | 0.0026 | 0.0010 | 0.0055 | 0.010 | 0.0005 | 0.0009 | 0.091 | 0.041 |
| 36 | 3.7 | 0.5 | 0.3 | 0.0028 | 0.0026 | 0.0033 | 0.014 | 0.0027 | 0.0006 | 0.014 | 0.053 |
| 37 | 3.4 | 0.8 | 0.5 | 0.0022 | 0.0036 | 0.0015 | 0.011 | 0.0011 | 0.0011 | 0.001 | 0.063 |
| 38 | 3.9 | 0.7 | 0.3 | 0.0021 | 0.0014 | 0.0124 | 0.016 | 0.0006 | 0.0016 | 0.003 | 0.041 |
| 39 | 3.5 | 0.7 | 0.4 | 0.0018 | 0.0041 | 0.0073 | 0.010 | 0.0006 | 0.0005 | 0.009 | 0.030 |
| 40 | 3.4 | 0.6 | 0.3 | 0.0017 | 0.0034 | 0.0120 | 0.031 | 0.0015 | 0.0016 | 0.043 | 0.037 |
| 41 | 3.5 | 0.7 | 0.3 | 0.0021 | 0.0047 | 0.0140 | 0.021 | 0.0006 | 0.0007 | 0.004 | 0.041 |
| 42 | 3.8 | 0.6 | 0.5 | 0.0024 | 0.0028 | 0.0010 | 0.013 | 0.0006 | 0.0028 | 0.001 | 0.027 |
| 43 | 3.3 | 0.4 | 0.7 | 0.0024 | 0.0015 | 0.0041 | 0.014 | 0.0006 | 0.0027 | 0.002 | 0.024 |
| 44 | 3.7 | 1.2 | 0.3 | 0.0023 | 0.0013 | 0.0023 | 0.013 | 0.0013 | 0.0013 | 0.023 | 0.051 |
| 45 | 3.7 | 0.4 | 0.5 | 0.0018 | 0.0016 | 0.0024 | 0.011 | 0.0012 | 0.0012 | 0.077 | 0.041 |
| 46 | 3.3 | 1.5 | 0.7 | 0.0024 | 0.0021 | 0.0030 | 0.021 | 0.0008 | 0.0006 | 0.069 | 0.066 |
| 47 | 3.8 | 0.6 | 0.3 | 0.0023 | 0.0014 | 0.0120 | 0.011 | 0.0005 | 0.0005 | 0.098 | 0.051 |
| 48 | 3.7 | 1.6 | 0.4 | 0.0021 | 0.0047 | 0.0023 | 0.023 | 0.0013 | 0.0029 | 0.070 | 0.053 |
| 49 | 3.3 | 1.1 | 0.7 | 0.0026 | 0.0037 | 0.0181 | 0.014 | 0.0005 | 0.0029 | 0.088 | 0.061 |
| 50 | 3.6 | 0.7 | 0.6 | 0.0016 | 0.0017 | 0.0145 | 0.011 | 0.0010 | 0.0013 | 0.028 | 0.041 |
| 51 | 3.7 | 0.5 | 0.6 | 0.0023 | 0.0044 | 0.0027 | 0.023 | 0.0020 | 0.0008 | 0.040 | 0.031 |
| 52 | 3.2 | 0.4 | 0.4 | 0.0018 | 0.0016 | 0.0021 | 0.0017 | 0.0011 | 0.0016 | — | — |
| 53 | 3.7 | 0.8 | 0.3 | 0.0027 | 0.0049 | 0.0041 | 0.008 | 0.0006 | 0.0025 | 0.005 | 0.017 |
| 54 | 3.9 | 0.4 | 0.5 | 0.0026 | 0.0022 | 0.0170 | 0.011 | 0.0023 | 0.0007 | 0.015 | 0.014 |
| 55 | 3.8 | 0.6 | 0.4 | 0.0020 | 0.0014 | 0.0060 | 0.021 | 0.0022 | 0.0015 | 0.058 | 0.030 |
| 56 | 3.8 | 0.4 | 0.3 | 0.0024 | 0.0015 | 0.0059 | 0.016 | 0.0025 | 0.0012 | 0.012 | 0.034 |
| 57 | 3.5 | 0.7 | 0.4 | 0.0021 | 0.0016 | 0.0023 | 0.013 | 0.0007 | 0.0012 | — | — |

TABLE 1-2

| | Chemical Composition (unit is mass %; balance is Fe and impurities) | | | | | | | | | | | | | |
|---|---|---|---|---|---|---|---|---|---|---|---|---|---|---|
| Test Number | B | Zn | Ga | Ge | As | Ni | Cu | Sn | Sb | Ca | La | Ce | Nd | Mg |
| 1 | — | — | — | — | — | — | — | — | — | — | — | — | — | — |
| 2 | — | — | — | — | — | — | — | — | — | — | — | — | — | — |
| 3 | — | — | — | — | — | — | — | — | — | — | — | — | — | — |
| 4 | — | — | — | — | — | — | — | — | — | — | — | — | — | — |
| 5 | — | — | — | — | — | — | — | — | — | — | — | — | — | — |
| 6 | — | — | — | — | — | — | — | — | — | — | — | — | — | — |
| 7 | 0.0007 | — | — | — | — | — | — | — | — | — | — | — | — | — |
| 8 | — | 0.0023 | — | — | — | — | — | — | — | — | — | — | — | — |
| 9 | — | — | 0.0021 | — | — | — | — | — | — | — | — | — | — | — |
| 10 | — | — | — | 0.0036 | — | — | — | — | — | — | — | — | — | — |
| 11 | — | — | — | — | 0.0031 | — | — | — | — | — | — | — | — | — |
| 12 | — | — | — | — | — | 0.06 | — | — | — | — | — | — | — | — |
| 13 | — | — | — | — | — | — | 0.07 | — | — | — | — | — | — | — |
| 14 | — | — | — | — | — | — | — | 0.02 | — | — | — | — | — | — |
| 15 | — | — | — | — | — | — | — | — | 0.01 | — | — | — | — | — |
| 16 | — | — | — | — | — | — | — | — | — | 0.0014 | — | — | — | — |
| 17 | — | — | — | — | — | — | — | — | — | — | 0.0018 | — | — | — |
| 18 | — | — | — | — | — | — | — | — | — | — | — | 0.0012 | — | — |
| 19 | — | — | — | — | — | — | — | — | — | — | — | — | 0.0006 | — |
| 20 | — | — | — | — | — | — | — | — | — | — | — | — | — | 0.0008 |
| 21 | — | — | — | — | — | — | — | — | — | — | — | — | — | — |
| 22 | — | — | — | — | — | — | — | — | — | — | — | — | — | — |
| 23 | — | — | — | — | — | — | — | — | — | — | — | — | — | — |
| 24 | — | — | — | — | — | — | — | — | — | — | — | — | — | — |
| 25 | — | — | — | — | — | — | — | — | — | — | — | — | — | — |
| 26 | — | — | — | — | — | — | — | — | — | — | — | — | — | — |
| 27 | — | — | — | — | — | — | — | — | — | — | — | — | — | — |
| 28 | — | — | — | — | — | — | — | — | — | — | — | — | — | — |
| 29 | — | — | — | — | — | — | — | — | — | — | — | — | — | — |
| 30 | — | — | — | — | — | — | — | — | — | — | — | — | — | — |
| 31 | 0.0009 | — | 0.0009 | — | 0.0009 | 0.08 | — | 0.02 | — | 0.0009 | 0.0008 | — | — | 0.0023 |
| 32 | — | 0.0048 | — | — | — | — | 0.01 | 0.07 | — | — | 0.0002 | 10.0021 | 0.0007 | — |
| 33 | — | 0.0002 | 0.0046 | 0.0020 | — | — | 0.14 | 0.06 | 0.04 | 0.0011 | 0.0011 | — | — | 0.0023 |
| 34 | — | — | — | 0.0043 | — | — | 0.23 | 0.12 | 0.02 | 0.0008 | — | 0.0026 | — | — |
| 35 | — | — | — | 0.0010 | 0.0093 | 0.14 | 0.04 | 0.04 | 0.01 | 0.0006 | — | — | 0.0003 | 0.0015 |
| 36 | 0.0002 | — | 0.0013 | — | — | 0.48 | — | — | 0.03 | 0.0009 | — | 0.0002 | — | 0.0013 |
| 37 | — | — | — | — | — | — | 0.43 | 0.02 | — | — | — | — | — | — |
| 38 | 0.0001 | — | — | — | 0.0034 | — | 0.31 | 0.16 | — | 0.0003 | — | — | 0.0007 | — |
| 39 | — | — | — | — | — | — | 0.16 | — | 0.08 | 0.0018 | 0.0031 | 0.0018 | — | 0.0004 |
| 40 | — | 0.0011 | 0.0015 | — | 0.0022 | 0.01 | 0.29 | 0.12 | — | 0.0043 | — | — | 0.0008 | 0.0006 |
| 41 | — | — | — | 0.0030 | — | — | 0.09 | 0.10 | 0.02 | 0.0035 | 0.0047 | 0.0028 | — | — |
| 42 | 0.0004 | — | — | — | — | 0.05 | 0.46 | — | — | — | 0.0008 | 0.0044 | 0.0003 | 0.0008 |
| 43 | — | — | — | — | — | — | — | 0.01 | — | 0.0028 | — | — | 0.0008 | 0.0012 |
| 44 | 0.0001 | — | — | 0.0022 | 0.0070 | 0.02 | 0.07 | 0.03 | — | — | 0.0006 | — | 0.0010 | 0.0026 |
| 45 | — | — | 0.0040 | 0.0006 | 10.0020 | — | — | | 0.05 | 0.0015 | — | 0.0018 | — | — |
| 46 | — | 0.0031 | — | — | — | 0.07 | — | 0.04 | 0.07 | — | — | 0.0002 | — | — |
| 47 | — | — | 0.0022 | — | 0.0029 | — | 0.09 | 0.01 | — | 0.0003 | 0.0010 | — | 0.0007 | 0.0025 |
| 48 | — | 0.0023 | — | 0.0019 | 10.0020 | 0.05 | — | 0.07 | — | — | — | — | — | — |
| 49 | 0.0002 | — | 0.0003 | 0.0030 | — | 0.48 | 0.01 | 0.01 | 0.02 | — | — | 0.0009 | — | — |
| 50 | — | — | — | — | — | — | — | — | — | — | — | — | — | — |
| 51 | — | 0.0014 | 0.0004 | — | 0.0047 | 0.01 | 0.10 | 0.06 | — | 0.0005 | 0.0046 | 10.0030 | 0.0003 | 0.0015 |
| 52 | — | — | — | — | — | — | — | — | — | — | — | — | — | — |
| 53 | — | — | — | — | — | — | — | — | — | — | — | — | — | — |
| 54 | — | 0.0008 | 0.0027 | 0.0007 | — | 0.02 | 0.25 | 0.15 | — | 0.0002 | 0.0012 | 0.0005 | — | — |
| 55 | — | — | — | — | — | — | — | — | — | — | — | — | — | — |
| 56 | 0.0004 | — | — | 0.0006 | — | 0.05 | 0.34 | 0.01 | 0.01 | — | 0.0012 | 0.0038 | — | — |
| 57 | — | — | — | — | — | — | — | — | — | — | — | — | — | — |

Slabs (cast pieces) were subjected to hot rolling to produce hot-rolled steel sheets having a thickness of 2.0 mm. The slab heating temperature was 1000° C. to 1300° C. The rolling finishing temperature was 800 to 1100° C. The coiling temperature was 500 to 800° C. Each hot-rolled steel sheet was subjected to hot-rolled sheet annealing in which the hot-rolled steel sheet was held at 1000° C. for one minute. Each steel sheet after the hot-rolled sheet annealing was subjected to cold rolling to produce a cold-rolled steel sheet having a thickness of 0.25 mm.

Each produced cold-rolled steel sheet was subjected to final annealing. The annealing temperature T1 (° C.), tension TE1 (kgf/mm²), average cooling rate CR1 (° C./sec), and tension TE2 (kgf/mm²) in the final annealing are shown in Table 2. A non-oriented electrical steel sheet of each test number was produced by the above production process.

TABLE 2

| | Final Annealing Process | | | | |
|---|---|---|---|---|---|
| | | | Condition | | Condition |
| | Condition | Condition | 3 | | 4 |
| | 1 | 2 | Average | | Maximum |
| | Annealing | Tension | Cooling | | Tension |
| Test | Temperature | TE1 | Rate CR1 | TE1 + | TE2 |
| Number | T1 (° C.) | (kgf/mm²) | (° C./sec) | 0.15 | (kgf/mm²) |
| 1 | 800 | 0.18 | 19 | 0.33 | 0.43 |
| 2 | 780 | 0.23 | 11 | 0.38 | 0.43 |
| 3 | 900 | 0.17 | 11 | 0.32 | 0.51 |
| 4 | 830 | 0.15 | 17 | 0.30 | 0.44 |
| 5 | 870 | 0.15 | 11 | 0.30 | 0.41 |
| 6 | 840 | 0.18 | 19 | 0.33 | 0.42 |
| 7 | 850 | 0.21 | 15 | 0.36 | 0.42 |
| 8 | 780 | 0.16 | 10 | 0.31 | 0.48 |
| 9 | 760 | 0.16 | 19 | 0.31 | 0.43 |
| 10 | 810 | 0.21 | 11 | 0.36 | 0.46 |
| 11 | 790 | 0.26 | 10 | 0.41 | 0.51 |
| 12 | 850 | 0.15 | 10 | 0.30 | 0.53 |
| 13 | 840 | 0.27 | 10 | 0.42 | 0.56 |
| 14 | 760 | 0.29 | 18 | 0.44 | 0.58 |
| 15 | 810 | 0.15 | 15 | 0.30 | 0.45 |
| 16 | 780 | 0.16 | 16 | 0.31 | 0.42 |
| 17 | 890 | 0.26 | 20 | 0.41 | 0.61 |
| 18 | 810 | 0.29 | 12 | 0.44 | 0.56 |
| 19 | 830 | 0.29 | 17 | 0.44 | 0.53 |
| 20 | 800 | 0.15 | 17 | 0.30 | 0.41 |
| 21 | 810 | 0.16 | 13 | 0.31 | 0.47 |
| 22 | 940 | 0.25 | 15 | 0.40 | 0.64 |
| 23 | 900 | 0.18 | 17 | 0.33 | 0.48 |
| 24 | 940 | 0.22 | 13 | 0.37 | 0.63 |
| 25 | 920 | 0.24 | 16 | 0.39 | 0.59 |
| 26 | 760 | 0.15 | 17 | 0.30 | 0.63 |
| 27 | 900 | 0.25 | 19 | 0.40 | 0.48 |
| 28 | 910 | 0.25 | 15 | 0.40 | 0.56 |
| 29 | 880 | 0.18 | 10 | 0.33 | 0.54 |
| 30 | 830 | 0.16 | 16 | 0.31 | 0.48 |
| 31 | 820 | 0.20 | 18 | 0.35 | 0.43 |
| 32 | 920 | 0.19 | 14 | 0.34 | 0.58 |
| 33 | 850 | 0.24 | 19 | 0.39 | 0.63 |
| 34 | 760 | 0.30 | 15 | 0.45 | 0.51 |
| 35 | 830 | 0.31 | 17 | 0.46 | 0.48 |
| 36 | 910 | 0.25 | 16 | 0.40 | 0.48 |
| 37 | 860 | 0.33 | 18 | 0.48 | 0.49 |
| 38 | 830 | 0.31 | 17 | 0.46 | 0.50 |
| 39 | 870 | 0.21 | 16 | 0.36 | 0.51 |
| 40 | 860 | 0.19 | 10 | 0.34 | 0.56 |
| 41 | 880 | 0.22 | 18 | 0.37 | 0.54 |
| 42 | 940 | 0.26 | 14 | 0.41 | 0.61 |
| 43 | 860 | 0.31 | 15 | 0.46 | 0.49 |
| 44 | 820 | 0.22 | 17 | 0.37 | 0.47 |
| 45 | 930 | 0.22 | 16 | 0.37 | 0.51 |
| 46 | 910 | 0.31 | 18 | 0.46 | 0.53 |
| 47 | 850 | 0.32 | 19 | 0.47 | 0.56 |
| 48 | 840 | 0.24 | 14 | 0.39 | 0.41 |
| 49 | 830 | 0.22 | 13 | 0.37 | 0.56 |
| 50 | 960 | 0.33 | 11 | 0.48 | 0.68 |
| 51 | 980 | 0.27 | 14 | 0.42 | 0.66 |
| 52 | 770 | 0.83 | 16.0 | 0.98 | 1.03 |
| 53 | 790 | 0.18 | 21 | 0.33 | 0.53 |
| 54 | 810 | 0.25 | 25 | 0.40 | 0.61 |
| 55 | 920 | 0.18 | 15 | 0.33 | 0.30 |
| 56 | 910 | 0.30 | 19 | 0.45 | 0.41 |
| 57 | 830 | 0.17 | 17.0 | 0.32 | 0.37 |

### [Evaluation Tests]

The non-oriented electrical steel sheet of each test number was subjected to the following evaluation tests.
(Test 1) Chemical composition measurement test
(Test 2) Tensile strength TS and yield strength YP measurement test
(Test 3) Test to measure [P]_{GB} and [P]_{IG}
(Test 4) Test to measure average grain size D
(Test 5) Magnetic properties evaluation test
(Test 6) Blanking workability evaluation test
(Test 7) Toughness evaluation test Test 1 to test 7 are described hereunder.

### [(Test 1) Chemical Composition Measurement Test]

The chemical composition of the non-oriented electrical steel sheet of each test number was determined according to the method described above in the section [Method for measuring chemical composition of non-oriented electrical steel sheet].

The chemical composition of the non-oriented electrical steel sheet of each test number determined as a result was as shown in Table 1-1 and Table 1-2.

### [(Test 2) Tensile Strength TS and Yield Strength YP Measurement Test]

The tensile strength TS (MPa) and yield strength YP (MPa) of the non-oriented electrical steel sheet of each test number were determined according to the method described above in the section [Method for measuring tensile strength TS and yield strength YP]. The obtained tensile strength TS (MPa) and yield strength YP (MPa) are shown in Table 3. In addition, the difference ΔS (=TS−YP) is shown in the column “ΔS (MPa)” in Table 3.

TABLE 3

| | | | | | | | Magnetic | | | | | |
|---|---|---|---|---|---|---|---|---|---|---|---|---|
| | | | | | | | Properties | | | | | |
| | Tensile | Yield | P | | Average | | Magnetic | Iron | Blanking Workability | | | |
| | Strength | Strength | Segregation | | Grain | | Flux | Loss | | Shear | Fatigue | |
| Test | TS | YP | Amount | ΔS | Size D | | Density | W_{5/1000} | Dimensional | Droop | Strength | |
| Number | (MPa) | (MPa) | [P]_{GB}/[P]_{IG} | (MPa) | (μm) | FN | B₅₀ (T) | (W/kg) | Accuracy | Amount | (MPa) | Remarks |
| 1 | 628 | 531 | 4.4 | 97 | 18 | 36 | 1.69 | 17.5 | E | E | 680 | Inventive |
| | | | | | | | | | | | | Example |
| 2 | 598 | 506 | 4.7 | 92 | 15 | 32 | 1.68 | 18.7 | E | E | 450 | Inventive |
| | | | | | | | | | | | | Example |
| 3 | 598 | 491 | 3.7 | 107 | 38 | 47 | 1.66 | 14.2 | E | E | 440 | Inventive |
| | | | | | | | | | | | | Example |
| 4 | 651 | 551 | 2.5 | 100 | 22 | 65 | 1.66 | 15.6 | E | E | 500 | Inventive |
| | | | | | | | | | | | | Example |
| 5 | 634 | 528 | 3.4 | 106 | 30 | 51 | 1.65 | 14.4 | E | E | 480 | Inventive |
| | | | | | | | | | | | | Example |
| 6 | 596 | 495 | 2.1 | 101 | 24 | 71 | 1.67 | 15.8 | E | E | 450 | Inventive |
| | | | | | | | | | | | | Example |
| 7 | 601 | 497 | 3.0 | 104 | 26 | 57 | 1.68 | 15.7 | E | E | 450 | Inventive |
| | | | | | | | | | | | | Example |
| 8 | 657 | 568 | 3.6 | 89 | 15 | 48 | 1.65 | 17.9 | E | F | 510 | Inventive |
| | | | | | | | | | | | | Example |
| 9 | 620 | 528 | 4.2 | 92 | 13 | 39 | 1.69 | 19.6 | E | E | 470 | Inventive |
| | | | | | | | | | | | | Example |
| 10 | 651 | 555 | 4.7 | 96 | 19 | 32 | 1.66 | 16.4 | E | E | 500 | Inventive |
| | | | | | | | | | | | | Example |
| 11 | 596 | 502 | 4.1 | 94 | 16 | 41 | 1.69 | 18.2 | E | E | 450 | Inventive |
| | | | | | | | | | | | | Example |
| 12 | 642 | 543 | 3.1 | 99 | 26 | 56 | 1.66 | 15.2 | E | E | 490 | Inventive |
| | | | | | | | | | | | | Example |
| 13 | 660 | 565 | 3.3 | 95 | 24 | 53 | 1.66 | 15.3 | E | E | 510 | Inventive |
| | | | | | | | | | | | | Example |
| 14 | 679 | 599 | 3.2 | 80 | 13 | 54 | 1.67 | 19.2 | E | E | 540 | Inventive |
| | | | | | | | | | | | | Example |
| 15 | 659 | 563 | 3.2 | 96 | 19 | 54 | 1.66 | 16.5 | E | E | 510 | Inventive |
| | | | | | | | | | | | | Example |
| 16 | 688 | 603 | 3.5 | 85 | 15 | 50 | 1.67 | 18.1 | E | E | 540 | Inventive |
| | | | | | | | | | | | | Example |
| 17 | 625 | 522 | 2.1 | 103 | 35 | 74 | 1.65 | 13.9 | E | F | 470 | Inventive |
| | | | | | | | | | | | | Example |
| 18 | 626 | 534 | 3.5 | 92 | 19 | 50 | 1.66 | 16.9 | E | E | 480 | Inventive |
| | | | | | | | | | | | | Example |
| 19 | 599 | 503 | 3.6 | 96 | 22 | 49 | 1.66 | 16.1 | E | E | 450 | Inventive |
| | | | | | | | | | | | | Example |
| 20 | 613 | 516 | 4.4 | 97 | 18 | 36 | 1.68 | 17.4 | E | E | 460 | Inventive |
| | | | | | | | | | | | | Example |
| 21 | 608 | 512 | 2.9 | 96 | 19 | 59 | 1.67 | 16.7 | E | E | 460 | Inventive |
| | | | | | | | | | | | | Example |
| 22 | 590 | 482 | 2.5 | 108 | 51 | 65 | 1.66 | 13.6 | E | E | 440 | Inventive |
| | | | | | | | | | | | | Example |
| 23 | 638 | 530 | 2.1 | 108 | 35 | 71 | 1.62 | 13.2 | E | E | 480 | Inventive |
| | | | | | | | | | | | | Example |
| 24 | 638 | 532 | 2.7 | 106 | 51 | 62 | 1.65 | 13.3 | E | F | 480 | Inventive |
| | | | | | | | | | | | | Example |
| 25 | 622 | 522 | 2.5 | 100 | 44 | 65 | 1.59 | 13.2 | E | E | 470 | Inventive |
| | | | | | | | | | | | | Example |
| 26 | 618 | 533 | 3.1 | 85 | 13 | 56 | 1.69 | 19.7 | E | E | 480 | Inventive |
| | | | | | | | | | | | | Example |
| 27 | 646 | 541 | 2.3 | 105 | 36 | 68 | 1.63 | 13.5 | E | E | 490 | Inventive |
| | | | | | | | | | | | | Example |
| 28 | 619 | 515 | 2.6 | 104 | 38 | 63 | 1.62 | 13.2 | E | E | 470 | Inventive |
| | | | | | | | | | | | | Example |
| 29 | 651 | 551 | 2.9 | 100 | 29 | 59 | 1.65 | 14.6 | E | F | 500 | Inventive |
| | | | | | | | | | | | | Example |
| 30 | 619 | 518 | 4.2 | 101 | 23 | 39 | 1.67 | 16.0 | E | E | 470 | Inventive |
| | | | | | | | | | | | | Example |
| 31 | 628 | 533 | 3.0 | 95 | 18 | 57 | 1.67 | 17.1 | E | E | 480 | Inventive |
| | | | | | | | | | | | | Example |
| 32 | 622 | 516 | 2.9 | 106 | 41 | 59 | 1.65 | 13.6 | E | E | 470 | Inventive |
| | | | | | | | | | | | | Example |
| 33 | 591 | 496 | 2.6 | 95 | 25 | 64 | 1.66 | 15.7 | E | E | 450 | Inventive |
| | | | | | | | | | | | | Example |
| 34 | 620 | 535 | 4.1 | 85 | 13 | 41 | 1.68 | 19.8 | E | E | 480 | Inventive |
| | | | | | | | | | | | | Example |
| 35 | 616 | 519 | 2.9 | 97 | 21 | 59 | 1.66 | 16.2 | E | E | 470 | Inventive |
| | | | | | | | | | | | | Example |
| 36 | 589 | 480 | 2.2 | 109 | 42 | 70 | 1.67 | 14.2 | E | E | 430 | Inventive |
| | | | | | | | | | | | | Example |
| 37 | 591 | 489 | 2.9 | 102 | 27 | 59 | 1.67 | 15.3 | E | E | 440 | Inventive |
| | | | | | | | | | | | | Example |
| 38 | 643 | 544 | 3.4 | 99 | 24 | 51 | 1.66 | 15.5 | E | F | 490 | Inventive |
| | | | | | | | | | | | | Example |
| 39 | 589 | 485 | 2.6 | 104 | 30 | 64 | 1.67 | 15.0 | E | E | 440 | Inventive |
| | | | | | | | | | | | | Example |
| 40 | 585 | 484 | 3.9 | 101 | 36 | 44 | 1.68 | 14.8 | E | E | 420 | Inventive |
| | | | | | | | | | | | | Example |
| 41 | 589 | 486 | 2.2 | 103 | 41 | 70 | 1.67 | 14.4 | E | F | 420 | Inventive |
| | | | | | | | | | | | | Example |
| 42 | 602 | 494 | 2.4 | 108 | 53 | 66 | 1.65 | 13.4 | E | E | 450 | Inventive |
| | | | | | | | | | | | | Example |
| 43 | 585 | 484 | 3.2 | 101 | 26 | 55 | 1.67 | 15.6 | E | E | 440 | Inventive |
| | | | | | | | | | | | | Example |
| 44 | 649 | 555 | 2.8 | 94 | 17 | 60 | 1.66 | 17.0 | E | E | 500 | Inventive |
| | | | | | | | | | | | | Example |
| 45 | 591 | 482 | 2.3 | 109 | 46 | 68 | 1.66 | 13.9 | E | E | 440 | Inventive |
| | | | | | | | | | | | | Example |
| 46 | 588 | 481 | 2.6 | 107 | 40 | 64 | 1.64 | 13.7 | E | E | 430 | Inventive |
| | | | | | | | | | | | | Example |
| 47 | 626 | 528 | 2.8 | 98 | 25 | 60 | 1.67 | 15.5 | E | E | 480 | Inventive |
| | | | | | | | | | | | | Example |
| 48 | 645 | 542 | 3.6 | 103 | 24 | 48 | 1.65 | 15.1 | E | E | 490 | Inventive |
| | | | | | | | | | | | | Example |
| 49 | 604 | 507 | 3.2 | 97 | 24 | 54 | 1.66 | 15.6 | E | E | 460 | Inventive |
| | | | | | | | | | | | | Example |
| 50 | 582 | 475 | 3.5 | 107 | 59 | 50 | 1.65 | 13.4 | E | E | 400 | Comparative |
| | | | | | | | | | | | | Example |
| 51 | 588 | 479 | 2.5 | 109 | 68 | 65 | 1.65 | 13.2 | E | E | 410 | Comparative |
| | | | | | | | | | | | | Example |
| 52 | 618 | 505 | 2.1 | 113 | 14 | 71 | 1.66 | 21.3 | E | B | 460 | Comparative |
| | | | | | | | | | | | | Example |
| 53 | 643 | 553 | 1.9 | 90 | 16 | 74 | 1.67 | 17.6 | B | E | 500 | Comparative |
| | | | | | | | | | | | | Example |
| 54 | 656 | 567 | 1.8 | 89 | 19 | 75 | 1.66 | 16.4 | B | E | 510 | Comparative |
| | | | | | | | | | | | | Example |
| 55 | 608 | 494 | 2.4 | 114 | 42 | 66 | 1.66 | 13.9 | E | B | 450 | Comparative |
| | | | | | | | | | | | | Example |
| 56 | 598 | 487 | 2.3 | 111 | 42 | 68 | 1.66 | 14.2 | E | B | 440 | Comparative |
| | | | | | | | | | | | | Example |
| 57 | 608 | 495 | 2.3 | 113 | 22 | 68 | 1.67 | 16.1 | E | B | 450 | Comparative |
| | | | | | | | | | | | | Example |

[(Test 3) Test to Measure [P]_{GB} and [P]_{IG}]

[P]_{GB} and [P]_{IG} of the non-oriented electrical steel sheet of each test number were determined according to the method described above in the section [Method for measuring [P]_{GB} and [P]_{IG}]. The obtained [P]_{GB}/[P]_{IG} are shown in Table 3.

### [(Test 4) Test to Measure Average Grain Size D]

The average grain size D (μm) of the non-oriented electrical steel sheet of each test number was determined according to the method described above in the section [Method for measuring average grain size D]. The obtained average grain size D (μm) is shown in Table 3. Note that, the value of FN (=100−15×[P]_{GB}/[P]_{IG}+1500/TS) is shown in the column “FN” in Table 3.

### [(Test 5) Magnetic Properties Evaluation Test]

Magnetic flux density B₅₀ and iron loss W_{5/1000} were determined by the following methods.

### [Method for Measuring Magnetic Flux Density B₅₀]

The magnetic flux density B₅₀ in the non-oriented electrical steel sheet of each test number was measured using Epstein test specimens in the rolling elongation direction (L direction) and in the direction perpendicular to the rolling elongation direction (C direction), with the number of test specimens divided equally between the two directions (14 test specimens in each direction). Specifically, Epstein test specimens were cut out from the non-oriented electrical steel sheet of each test number in accordance with JIS C 2550-1(2011), with half of the Epstein test specimens extending in the L direction and half of the Epstein test specimens extending in the C direction. The Epstein test specimens cut out were subjected to test methods for electrical steel strip and sheet according to JIS C 2550-1 (2011) and 2550-3 (2011), and the magnetic flux density B₅₀ at 5000 A/m that was the average of the L direction and the C direction was measured. The obtained magnetic flux density B₅₀ (T) is shown in Table 3.

### [Method for Measuring Iron Loss W_{5/1000}]

Epstein test specimens were prepared in a similar manner to the method for measuring the magnetic flux density B₅₀ described above. The Epstein test specimens were subjected to test methods for electrical steel strip and sheet according to JIS C 2550-1 (2011) and 2550-3 (2011), and the iron loss W_{5/1000} (W/kg) at 0.5 T at 1000 Hz that was the average of the L direction (rolling elongation direction) and the C direction (direction perpendicular to the rolling elongation direction) was measured. The obtained iron loss W_{5/1000} (W/kg) is shown in Table 3.

### [(Test 6) Blanking Workability Evaluation Test]

The blanking workability of the non-oriented electrical steel sheet of each test number was evaluated by the following test. A ring-shaped sample having an inner diameter of 90 mm and an outer diameter of 100 mm was cut out from the non-oriented electrical steel sheet of each test number using a press tooling in which the clearance was set to 20 μm.

The dimensional accuracy was evaluated by the following method. First, the inner diameter and outer diameter of the cut ring-shaped sample were measured with a dimension measuring instrument. Using the measured inner diameter, the maximum amount of deviation between the measured inner diameter and a perfect circle (90 μm) (the maximum value of the difference between the measured inner diameter and the perfect circle) was determined. In addition, using the measured outer diameter, the maximum amount of deviation between the measured outer diameter and a perfect circle (100 mm) was determined. In a case where the maximum amount of deviation of the inner diameter and the maximum amount of deviation of the outer diameter were each 20 μm or less, it was determined that excellent dimensional accuracy was obtained (indicated by “E (Excellent)” in the “Dimensional Accuracy” column of the “Blanking Workability” column in Table 3). On the other hand, in a case where even either one of the maximum amount of deviation of the inner diameter and the maximum amount of deviation of the outer diameter was more than 20 μm, it was determined that excellent dimensional accuracy was not obtained (indicated by “B (Bad)” in the “Dimensional Accuracy” column of the “Blanking Workability” column in Table 3).

The shear droop amount was evaluated by the following method. The ring-shaped sample was cut into an L-direction cross section. The cut ring-shaped sample was embedded in resin, and the L-direction cross section was polished. After polishing, a cut end surface portion of the inner peripheral surface (inner diameter) and a cut end surface portion of the outer peripheral surface (outer diameter) of the L-direction cross section were observed with an optical microscope at a magnification of 100×. FIG. 4 is an enlarged view of a portion including the cut end surface in the L-direction cross section of the ring-shaped sample. Referring to FIG. 4, an intersection point position P1 between a shear droop portion 20 and a cut end surface 30 was identified. For each of the inner peripheral surface and the outer peripheral surface, if a distance t1 in the thickness direction from a surface 10 of the ring-shaped sample to the intersection point position P1 was within a range from the surface 10 to a position corresponding to ¼ of the sheet thickness t0 (that is, the thickness of the non-oriented electrical steel sheet), it was determined that a shear droop amount was sufficiently suppressed (indicated by “E (Excellent)” in the “Shear Droop Amount” column of the “Blanking Workability” column in Table 3). On the other hand, if the distance t1 exceeded the range from the surface 10 to a position corresponding to ¼ of the sheet thickness to (that is, the thickness of the non-oriented electrical steel sheet) on at least one of the inner peripheral surface and the outer peripheral surface, it was determined that a shear droop amount could not be sufficiently suppressed (indicated by “B (Bad)” in the “Shear Droop Amount” column of the “Blanking Workability” column in Table 3).

In a case where excellent dimensional accuracy was obtained and a shear droop amount was sufficiently suppressed, it was determined that excellent blanking workability was obtained.

### [(Test 7) Toughness Evaluation Test]

The toughness of the non-oriented electrical steel sheet of each test number was evaluated by a fatigue test. Specifically, a fatigue test specimen having the L direction serving as the longitudinal direction was taken from the non-oriented electrical steel sheet of each test number. The fatigue test specimen had a width of 30 mm and a length of 180 mm, and a parallel portion located at the center in the longitudinal direction of the fatigue test specimen had a width of 15 mm and a length of 35 mm. The parallel portion end faces and rounded portion end faces of the fatigue test specimen were polished with #600 emery paper.

The following fatigue test was conducted in the atmosphere at normal temperature using the fatigue test specimen described above. In the fatigue test, the stress ratio was set to 0.05 pulsations (tensile-tensile), and the frequency was set to 20 Hz. The stress amplitude at which fracturing did not occur even after 2 million repetitions was defined as the fatigue strength (MPa).

### [Evaluation Results]

Referring to Table 1-1, Table 1-2, Table 2, and Table 3, the non-oriented electrical steel sheets of Test Nos. 1 to 49 satisfied feature 1 to feature 5. Therefore, the magnetic flux density B₅₀ was 1.55 T or more, and the iron loss W_{5/1000} was 20.0 W/kg or less. In addition, excellent blanking workability was obtained. Furthermore, the fatigue strength was 420 MPa or more and excellent toughness was obtained.

In Test Nos. 50 and 51, the annealing temperature was too high. Consequently, the average grain size D did not satisfy Formula (2). Therefore, the fatigue strength was less than 420 MPa, and sufficient toughness was not obtained.

In Test No. 52, the tension TE1 applied to the cold-rolled steel sheet during final annealing was too high. Consequently, the difference ΔS was more than 110 MPa. Therefore, the shear droop amount could not be sufficiently suppressed, and excellent dimensional accuracy was not obtained. Further, the iron loss W_{5/1000} (W/kg) was high.

In Test Nos. 53 and 54, the average cooling rate CR1 was too fast. Consequently, [P]_{GB}/[P]_{IG} was less than 2.0. Therefore, in the blanking workability evaluation test, the maximum amount of deviation of the inner diameter and/or the maximum amount of deviation of the outer diameter was more than 20 μm and excellent dimensional accuracy was not obtained.

In Test Nos. 55 to 57, the tension TE2 was too low. Consequently, the difference ΔS was more than 110 MPa. Therefore, the shear droop amount could not be sufficiently suppressed, and excellent blanking workability was not obtained.

Whilst a preferred embodiment of the present invention has been described above, the present invention is not limited to the above example. It is clear that those skilled in the art will be able to contrive various examples of changes and modifications within the category of the technical idea described in the appended claims, and it should be understood that they also naturally belong to the technical scope of the present invention.

1. A non-oriented electrical steel sheet consisting of, in mass %,
Si: 3.2 to 4.5%,
Mn: 0.3 to 3.5%,
sol. Al: 0.2 to 2.0%,
C: 0.0010 to 0.0030%,
N: more than 0% to 0.0050% or less,
O: more than 0% to 0.0200% or less,
P: more than 0% to 0.100% or less,
S: more than 0% to 0.0030% or less,
Ti: more than 0% to 0.0030% or less,
Mo: 0 to 0.100%,
Cr: 0 to 1.000%,
Ni: 0 to 0.50%,
Cu: 0 to 0.50%,
B: 0 to 0.0010%,
Zn: 0 to 0.0050%,
Ga: 0 to 0.0050%,
Ge: 0 to 0.0050%,
As: 0 to 0.0100%,
Sn: 0 to 0.20%,
Sb: 0 to 0.10%,
Ca: 0 to 0.0050%,
La: 0 to 0.0050%,
Ce: 0 to 0.0050%,
Nd: 0 to 0.0010%, and
Mg: 0 to 0.0030%,
with the balance being Fe and impurities,
wherein:
a tensile strength TS is higher than 580 MPa;
when elemental analysis is performed by Auger electron spectroscopy in a grain boundary region of a fracture surface of the non-oriented electrical steel sheet to obtain Auger differential spectrum of Fe and P, and P₁₂₀/Fe₇₀₀ that is a ratio of a peak-to-peak value P₁₂₀ of P around an electron energy of 120 eV to a peak-to-peak value Fe₇₀₀ of Fe around an electron energy of 700 eV in the Auger differential spectrum obtained is defined as [P]_{GB}, and
elemental analysis is performed by Auger electron spectroscopy in an intragranular region of a fracture surface of the non-oriented electrical steel sheet to obtain Auger differential spectrum of Fe and P, and P₁₂₀/Fe₇₀₀ that is a ratio of a peak-to-peak value P₁₂₀ of P around an electron energy of 120 eV to a peak-to-peak value Fe₇₀₀ of Fe around an electron energy of 700 eV in the Auger differential spectrum obtained is defined as [P]_{IG},
the [P]_{GB} and the [P]_{IG} satisfy Formula (1);
a difference ΔS between the tensile strength TS and a yield strength YP is 110 MPa or less; and
an average grain size D (μm) satisfies Formula (2);
$${[ P ]}_{G B} {/ [ P ]}_{I G} > 2.0 \qquad ( 1 )$$
$$D \leq 100 - 15 \times {[ P ]}_{G B} {/ [ P ]}_{I G} + 1 \; 500 / TS \qquad ( 2 )$$
where, a numerical value of the tensile strength TS (MPa) is substituted for TS in Formula (2).

2. The non-oriented electrical steel sheet according to claim 1, containing one or more types of element selected from a group consisting of, in mass %,
Mo: 0.001 to 0.100%,
Cr: 0.001 to 1.000%,
Ni: 0.01 to 0.50%,
Cu: 0.01 to 0.50%,
B: 0.0001 to 0.0010%,
Zn: 0.0001 to 0.0050%,
Ga: 0.0001 to 0.0050%,
Ge: 0.0001 to 0.0050%,
As: 0.0001 to 0.0100%,
Sn: 0.01 to 0.20%,
Sb: 0.01 to 0.10%,
Ca: 0.0001 to 0.0050%,
La: 0.0001 to 0.0050%,
Ce: 0.0001 to 0.0050%,
Nd: 0.0001 to 0.0010%, and
Mg: 0.0001 to 0.0030%.

3. A method for producing the non-oriented electrical steel sheet according to claim 1, comprising:
a hot rolling process of subjecting a slab having a chemical composition according to claim 1 to hot rolling to produce a hot-rolled steel sheet,
a cold rolling process of subjecting the hot-rolled steel sheet to cold rolling to produce a cold-rolled steel sheet, and
a final annealing process of subjecting the cold-rolled steel sheet to final annealing,
wherein, in the final annealing process:
the cold-rolled steel sheet is annealed at a highest temperature reached T1 of 950° C. or less,
a tension TE1 applied to the cold-rolled steel sheet during annealing is set to 0.15 to 0.80 kgf/mm²,
during cooling of the cold-rolled steel sheet after annealing, an average cooling rate CR1 in a temperature range of 700 to 500° C. is set to 20° C./sec or less, and
during cooling of the cold-rolled steel sheet after annealing, a maximum tension TE2 applied to the cold-rolled steel sheet in a temperature range of 200° C. or less is set to TE1+0.15 kgf/mm² or more and 0.40 kgf/mm² or more.
